(19) United States
(12) Patent Application Publication
(10) Pub. No.: US 2026/0039680 A1
(43) Pub. Date: Feb. 5, 2026

(54) ASSESSING SECURITY RISK AT SCALE FOR A COMPUTING ENVIRONMENT

(71) Applicant: Oracle International Corporation, Redwood Shores, CA (US)

(72) Inventors: Robert Eugene Sandbothe, JR., Dublin, CA (US); Peter Albert Hewson, JR., Victoria, MN (US)

(73) Assignee: Oracle International Corporation, Redwood Shores, CA (US)

(21) Appl. No.: 18/792,024

(22) Filed: Aug. 1, 2024

(51) Int. Cl. H04L 9/40

(52) U.S. Cl. CPC H04L 63/1433

(57) ABSTRACT

Techniques for assessing security risk at scale for a computing environment are disclosed. In an example method, a computing system accesses a risk model specified for a computing environment including at least a set of individual risk factors, a set of composite risk factors, and a final composite function for computing an overall risk score. The computing system receives a set of one or more inputs. The computing system computes an individual risk score for each individual risk factor using at least one input. The computing system computes a composite risk score for each composite risk factor. The computing system computes the overall risk score using the final composite function using at least two composite risk scores and outputs the overall risk score.

### FIELD

The present disclosure relates generally to techniques for assessing security risk at scale in a distributed computing environment. In particular, the present disclosure describes a security system that determines an overall risk for a computing environment using a risk model, where the risk model is executed by the security system and defines a flexible combination of individual and composite risk factors that contribute to the overall risk for the computing environment.

### BACKGROUND

Distributed computing systems are continually under attack by bad actors from every corner of the globe. As the complexity of these distributed systems grows, so too does the complexity of the security threats faced by operators of these systems. The security threat has been further magnified with the rising popularity of cloud services. As the adoption of cloud services has grown, an increasing amount of customer-confidential data is now stored in distributed data centers provided by the cloud service providers (CSPs). Bad actors are constantly trying to hack into these data centers to gain unauthorized access to the confidential data of clients of the CSPs. CSP-provided infrastructures used for providing cloud services are also under attack to degrade the performance of these systems. Being able to secure this infrastructure and data centers from malicious attacks is of utmost importance to the CSPs.

The success or failure of a CSP depends upon the CSP's ability to accurately assess security risks for CSP-provided computing infrastructure in a timely manner and take appropriate mitigation actions to prevent or minimize potential damage posed by the factors contributing to the risks. Assessing security risks, especially for a complex distributed computing environment, is however deceptively difficult. Risk, in this sense, refers to the potential for loss or damage if a particular threat were to be exploited in the context of a specific computing environment.

There are no standard approaches for assessing and quantifying security risk for a distributed computing environment. This is because there is no one-size-fits-all way to assess security risk since risk is inherently a matter of perspective and specific to the computing environment being assessed. Some existing approaches, for instance, rely on risk matrices, which are used in various industries, to prioritize risks and make decisions about where to allocate resources for risk mitigation efforts. For example, a risk matrix may involve a tabular presentation of the risk associated with a particular finding. Such risk matrices are however known to be inconsistent, involve arbitrary assignments of numerical values, and may even drive the opposite of the desired behavior when misapplied. Other industry tools, such as the Common Vulnerability Scoring System (CVSS) do not actually measure risk, in the sense used herein, and are frequently misapplied by organizations who do not understand this. Additionally, some proposed solutions to assessment of security risk are largely based on theoretical approaches that break down in practical real-life settings.

Many current security risk assessment solutions involve identifying findings in a computing environment, and then manually assessing the findings to determine risk exposure for the computing environment. These manual assessments are heavily influenced by the experience of the person making the assessment and are thus very inconsistent and arbitrary. The same finding may receive one severity value from one assessor and a completely different severity value by a different assessor. Especially for a large computing environment with a large number of findings, the manuals assessments are, at best, arbitrary and inconsistent, and at worst, completely incorrect, which can lead to disastrous results for the computing environment. Existing approaches frequently fail to prioritize mitigation efforts consistently or appropriately. As a result, the determined risk may be inflated or deflated relative to the reality of a given network context. Moreover, these inconsistencies can result in mixed messages to regulating or certifying agencies, who may demand a high level of documented consistency.

Security risk assessments are often used to drive business decisions for a CSP. For example, when customers sign up with a CSP and subscribe to one or more cloud services provided by the CSP, service level agreements (SLAs) are typically entered into by the CSP with its customers where the SLAs identify a level of service guaranteed by the CSP to the customers. These SLAs commonly include parameters governing security responses including, for example, time frames within which the CSP must respond to and resolve security incidents and vulnerabilities, expected performance levels, uptime guarantees, and so on. The inconsistent and arbitrary nature of current security solutions result in security teams for the CSP receiving conflicting signals on which threats are to be prioritized.

### BRIEF SUMMARY

The present disclosure relates generally to techniques for assessing security risk at scale in a distributed computing environment. In particular, the present disclosure describes a security system that determines an overall risk for a computing environment using a risk model, where the risk model is executed by the security system and defines a flexible combination of individual and composite risk factors that contribute to the overall risk for the computing environment.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

In certain embodiments, a Threat and Vulnerability Management Security System (TVMSS) is provided that is capable of computing an overall risk assessment for a computing environment using a risk model. In certain implementations, the risk assessment is in the form of an overall risk score that is computed by the TVMSS by executing the risk model, where the risk model identifies various individual and composite risk factors that contribute to the overall rick score, the manner in which scores are to be computed for the individual and composite risk factors, and how the scores computed for the individual and composite risk factors are to be used for computing the overall risk assessment score for the computing environment. In certain implementations, the TVMSS is also configured to initiate one or more actions in response to the overall risk score to prevent or mitigate any damage resulting from the factors contributing to the overall risk assessment score.

In certain implementations, a TVMSS accesses a risk model specified for a computing environment for which the risk assessment is to be performed. The scope of the computing environment is user-selectable. The risk model may include a set of individual risk factors, a set of composite risk factors, a final composite function for computing an overall risk score for the computing environment, for each individual risk factor in the set of individual risk factors: an individual risk factor function associated with the individual risk factor used for computing an individual risk factor score for the individual risk factor and one or more input parameters used by the individual risk factor function for computing the individual risk factor score, for each composite risk factor in the set of composite risk factors: a composite risk factor function associated with the composite risk factor used for computing a composite risk factor score for the composite risk factor and at least two input parameters used by the composite risk factor function for computing the composite risk factor score. The TVMSS may receive a set of one or more inputs. The TVMSS may then, for each individual risk factor in the set of individual risk factors, compute the individual risk factor score using the individual risk factor function associated with the individual risk factor, where the one or more input parameters used by the individual risk factor function include at least one input from the set of one or more inputs to the TVMSS. The TVMSS may then compute, for each composite risk factor in the set of composite risk factors, the composite risk factor score using the composite risk factor function associated with the composite risk factor. The TVMSS may then compute the overall risk score for the computing environment by using the final composite function, where the final composite function uses at least two composite risk factor scores computed for at least two composite risk factors in the set of composite risk factors for computing the overall risk score. The overall risk score may then be output to a consumer of the score.

In certain embodiments, the computing, for each composite risk factor in the set of composite risk factors, the composite risk factor score using the composite risk factor function associated with the composite risk factor may include, for a first composite risk factor in the set of composite risk factors, using a first composite risk factor function associated with the first composite risk factor to compute a first composite risk factor score for the first composite risk factor, in which using the first composite risk factor function can include using at least two individual risk factor scores. In some examples, the at least two individual risk factor scores can include a first individual risk factor score and a second individual risk factor score and the first composite risk factor function may include a first weight associated with the first individual risk factor score and a second weight associated with the second individual risk factor score, in which the first weight controls a contribution of the first individual risk factor score to the computation of the first composite risk factor score and the second weight controls a contribution of the second individual risk factor score to the computation of the first composite risk factor score.

In certain embodiments, the computing, for each composite risk factor in the set of composite risk factors, the composite risk factor score using the composite risk factor function associated with the composite risk factor may include, for a first composite risk factor in the set of composite risk factors, using a first composite risk factor function associated with the first composite risk factor to compute a first composite risk factor score for the first composite risk factor, in which using the first composite risk factor function can include using at least two other composite risk factor scores computed for at least two other composite risk factors. In some examples, the at least two composite risk factor scores can include a second composite risk factor score and a third composite risk factor score and the first composite risk factor function can include a first weight associated with the second composite risk factor score and a second weight associated with the third composite risk factor score, in which the first weight controls a contribution of the second composite risk factor score to the computation of the first composite risk factor score and the second weight controls a contribution of the third composite risk factor score to the computation of the first composite risk factor score.

In certain embodiments, the at least two composite risk factor scores may include a first composite risk factor score and a second composite risk factor score and the final composite function can includes a first weight associated with the first composite risk factor score and a second weight associated with the second composite risk factor score, in which the first weight controls a contribution of the first composite risk factor score to the computation of the overall risk score and the second weight controls a contribution of the second composite risk factor score to the computation of the overall risk score.

In certain embodiments, the TVMSS can determine a responsive action based upon the overall risk score exceeding a predetermined threshold.

In certain embodiments the receiving by the TVMSS, the computing by the TVMSS for each individual risk factor in the set of individual risk factors, the computing by the TVMSS for each composite risk factor in the set of composite risk factors, and the computing by the TVMSS of the overall risk score may be performed periodically or in response to receiving information about a finding.

In certain embodiments, the TVMSS can receive a request to compute an aggregate risk score for a first time period for the first computing environment. The TVMSS can then identify a number of overall risk scores computed for the first computing environment within the first time period, in which the number of overall risk scores includes the overall risk score computed for the first computing environment. The TVMSS can then compute the aggregate risk score based upon the identified number of overall risk scores. In some examples, the TVMSS can receive request to compute an aggregate risk score for a particular computing environment. The TVMSS can then determine that the particular computing environment includes a number of computing environments, the number of computing environments including the first computing environment. The TVMSS can identify a set of overall risk scores computed for the number of computing environments and compute the aggregate risk score for the particular computing environment based upon the set of overall risk scores. In some examples, computing the aggregate risk score can include using a log weighted average of the set of overall risk scores for computing the aggregate risk score. Each term of the log weighted average may include a weight that increases exponentially in proportion to each respective overall risk score of the one or more overall risk scores.

In certain embodiments, at least one second input of the set of one or more inputs can correspond to a finding. Computing the overall risk score may include computing the overall risk score as a product of a first composite risk factor score and a second composite risk factor score, in which the first composite risk factor score can be computed using a first composite risk factor function. The second composite risk factor score can be computed using a second composite risk factor function. The first composite risk factor function may include a first sum of a first nested composite risk factor score controlled by a first weight and a second nested composite risk factor score controlled by a second weight, in which the first nested composite risk factor score is based on a likelihood of the finding, the second nested composite risk factor score is based on an impact of the finding, and the second composite risk factor function evaluates to 0 if the severity of the finding is 0 and 1 otherwise. In some examples, at least one second input of the set of one or more inputs corresponds may include the Common Vulnerability Scoring System (CVSS) value of the finding or the Common Weakness Scoring System (CWSS) value of the finding and the severity of the finding is based on the CVSS value of the finding or the CWSS value of the finding. In some examples, the second nested composite risk factor score can be based on the impact of the finding is computed using a second nested composite risk factor function that evaluates to a number determined according to a service tier associated with the finding. In some examples, the first nested composite risk factor score can include a second sum of a third nested composite risk factor score controlled by a third weight and a fourth nested composite risk factor score controlled by a fourth weight divided by a third sum of the third weight and the fourth weight, in which the third nested composite risk factor score is based on an exposure of the finding and the fourth nested composite risk factor score is based on an exploit probability of the finding. In some examples, the third nested composite risk factor score based on the exposure of the finding can include a fourth sum of a first individual risk factor score controlled by a first individual risk factor weight and a second individual risk factor score controlled by a second individual risk factor weight divided by a fifth sum of the first individual risk factor weight and the second individual risk factor weight, in which the first individual risk factor score is based on the severity of the finding and the second individual risk factor score is based on a frequency of the finding and the frequency of the finding is a quotient of a number of services in the first computing environment having a same finding and a total number of services in the first computing environment. In some examples, the fourth nested composite risk factor score may be based on the exploit probability of the finding is determined based on a predicted exploit probability of the finding based on the Exploit Prediction Scoring System (EPSS).

In certain embodiments, the one or more inputs of the number of inputs may correspond to a finding and the final composite function may be given by a formula including a first composite risk factor score computed using a first composite risk factor function based on at least two composite risk factor scores relating to severity exposure. The final composite function may include a first weight that controls a first contribution of the first composite risk factor score. The final composite function may include a second composite risk factor score based on an impact of the finding and a second weight that controls a second contribution of the second composite risk factor score. The final composite function may include a third composite risk factor score based on a severity of the finding.

In certain embodiments, a non-transitory computer-readable medium storing instructions that, when executed by one or more processors, can cause the one or more processors to perform operations including accessing a risk model, by a TVMSS, specified for a computing environment for which the risk assessment is to be performed. The risk model may include a set of individual risk factors, a set of composite risk factors, a final composite function for computing an overall risk score for the computing environment, for each individual risk factor in the set of individual risk factors: an individual risk factor function associated with the individual risk factor used for computing an individual risk factor score for the individual risk factor and one or more input parameters used by the individual risk factor function for computing the individual risk factor score, for each composite risk factor in the set of composite risk factors: a composite risk factor function associated with the composite risk factor used for computing a composite risk factor score for the composite risk factor and at least two input parameters used by the composite risk factor function for computing the composite risk factor score. The TVMSS may receive a set of one or more inputs. The TVMSS may then, for each individual risk factor in the set of individual risk factors, compute the individual risk factor score using the individual risk factor function associated with the individual risk factor, where the one or more input parameters used by the individual risk factor function include at least one input from the set of one or more inputs to the TVMSS. The TVMSS may then compute, for each composite risk factor in the set of composite risk factors, the composite risk factor score using the composite risk factor function associated with the composite risk factor. The TVMSS may then compute the overall risk score for the computing environment by using the final composite function, where the final composite function uses at least two composite risk factor scores computed for at least two composite risk factors in the set of composite risk factors for computing the overall risk score. The overall risk score may then be output to a consumer of the score.

In certain embodiments, a security system may include one or more processors and one or more computer-readable storage media The computer-readable storage media may store instructions which, when executed by the one or more processors, cause the one or more processors to perform operations including accessing a risk model specified for a computing environment for which the risk assessment is to be performed. The risk model may include a set of individual risk factors, a set of composite risk factors, a final composite function for computing an overall risk score for the computing environment, for each individual risk factor in the set of individual risk factors: an individual risk factor function associated with the individual risk factor used for computing an individual risk factor score for the individual risk factor and one or more input parameters used by the individual risk factor function for computing the individual risk factor score, for each composite risk factor in the set of composite risk factors: a composite risk factor function associated with the composite risk factor used for computing a composite risk factor score for the composite risk factor and at least two input parameters used by the composite risk factor function for computing the composite risk factor score. The operations may include receiving a set of one or more inputs. The operations may include, for each individual risk factor in the set of individual risk factors, compute the individual risk factor score using the individual risk factor function associated with the individual risk factor, where the one or more input parameters used by the individual risk factor function include at least one input from the set of one or more inputs to the security system. The operations may include computing, for each composite risk factor in the set of composite risk factors, the composite risk factor score using the composite risk factor function associated with the composite risk factor. The operations may include computing the overall risk score for the computing environment by using the final composite function, where the final composite function uses at least two composite risk factor scores computed for at least two composite risk factors in the set of composite risk factors for computing the overall risk score. The overall risk score may then be output to a consumer of the score.

### BRIEF DESCRIPTION OF THE DRAWINGS

FIG. 1 depicts a system for assessing security risk at scale for a computing environment, according to some examples of the present disclosure.

FIG. 2A shows a schematic representation of a simplified risk model, according to some examples of the present disclosure.

FIG. 2B shows a schematic representation of an individual risk factor that is a component of risk model, according to some examples of the present disclosure.

FIG. 2C shows a schematic representation of a composite risk factor that is a component of risk model, according to some examples of the present disclosure.

FIG. 2D shows a schematic representation of a particular implementation of risk model, according to some examples of the present disclosure.

FIG. 2E shows a schematic representation of another particular implementation of risk model, according to some examples of the present disclosure.

FIGS. 3A-3B depict a simplified flowchart showing a method for assessing security risk at scale for a computing environment, according to some examples of the present disclosure.

FIG. 4 depicts a simplified flowchart showing a method for assessing security risk at scale for a computing environment, according to some examples of the present disclosure.

FIGS. 5A-5B depict simplified flowcharts showing methods for assessing aggregate security risk at scale for a computing environment, according to some examples of the present disclosure.

FIGS. 6A-6C illustrate an example final composite function of a risk model as well as the components therein, according to some examples of the present disclosure.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to techniques for assessing security risk at scale in a distributed computing environment. In particular, the present disclosure describes a security system that determines an overall risk score for a computing environment using a risk model, where the risk model is executed by the security system and defines a flexible combination of individual and composite risk factors that contribute to the overall risk for the computing environment.

A threat and vulnerability management security system (TVMSS) is described that is capable of assessing and quantifying the security risk for a computing environment in a repeatable and consistent manner. The TVMSS uses a risk model for computing an overall risk score for the computing environment in an automated manner, where the overall risk score is a measure of the overall risk for the computing environment and which takes into account various risk factors. The risk model is user-configurable and flexible for being configured in different computing environments. The risk model provides a repeatable, deterministic, and non-arbitrary template that is executed by the TVMSS for computing the overall risk score for the computing environment. The TVMSS along with the risk model enables security risk assessment for a computing environment to be automated and performed substantially free of any human intervention. In some cases, the risk assessment output generated by the TVMSS can be used to initiate an automatic action response to reduce the risk for the computing environment. This may, for example, be performed when the overall risk score computed for the computing environment exceeds a predetermined threshold value.

Assessing and quantifying risk for a computing environment is a challenging problem. Risk, as described herein, is a measure of the extent to which a computing environment controlled or operated by an organization (e.g., a CSP) is threatened under a particular set of conditions. For example, the computing environment may be a CSP-provided computing infrastructure in a particular region, a subset thereof, a portion of the CSPI allocated to a particular customer, an on-premise computing environment of a business or other organization, a small home or residential network, and so on.

The risk may measure the extent to which a particular computing environment is threatened by a set of threatening circumstances or events that have recently occurred or a set of potential threatening circumstances or events that may occur or are likely to occur. Examples of threatening events or circumstances include public or private disclosures of vulnerabilities, exploits, bugs, backdoors, in-progress or past attacks, and so on. Knowledge of such a circumstance or event is referred to herein as a finding, discussed further below.

In some use cases, to assess risk given knowledge of a specific threat, a security engineer determines the vulnerability of a particular computing environment under their purview to that threat. When computing environments become complex (e.g., the corporate network for a large company that provides software services on the internet, a distributed computing infrastructure provided by a CSP for providing cloud services, etc.), assessment of security risk at significant scale can quickly exceed what is practically possible using manual analysis techniques.

Risk can be a function of various factors such as the adverse impacts that would arise if a particular event occurred (e.g., if a vulnerability is exploited), the likelihood of occurrence of that event, and others. Determining which factors should be included in a risk assessment for a computing environment and the contributions of the individual factors towards the overall risk assessment for the environment is a very technically complex and challenging task. The complexity increases exponentially with increases in the size of the computing environment, the number of diverse components in the computing environment, and complexity of the environment.

Risk assessment generally involves determining a measure of risk given a number of inputs in a specific context. For instance, risk can be assessed in response to receiving information about one or more findings that affect a particular computing environment over a particular period of time. A finding refers generally to information about a vulnerability, security threat, known exploit, bug, or the like that may be indicative of risk. Such information may be obtained as a result of an event or circumstance, such as a public or private disclosure (e.g., information a bug is posted is to a public forum or privately obtained through award of a bounty). In practice, findings may be received in extremely large quantities. Security engineers may use a variety of tools or methods to manage the large volume of received findings.

As described above in the Background section, present techniques for assessing security risk for a computing environment have several deficiencies. The TVMSS described herein overcomes these deficiencies. As described herein, the TVMSS uses a risk model configured for a computing environment to compute an overall risk score for the computing environment. The overall risk score can be dependent upon various different individual risk factors, one or more composite risk factors, and particular relationships among these multiple factors. In certain implementations, these risk factors, the relationships between the risk factors, and techniques for computing the overall risk score are articulated in a risk model configured for the computing environment. The risk model may identify a set of inputs to be used for computing the overall risk scores, one or more individual risk factors to be used, functions for computing scores for the individual risk factors, one or more composite risk factors to be used, functions for computing scores for the composite risk factors, and a composite function for computing the overall risk score for the computing environment. In doing so, the techniques described herein begin with a set of predisposing conditions, exploitable weaknesses, or deficiencies in a given computing environment and quantify the probability that those vulnerabilities could be exploited together with the possible consequences.

Computation of the overall risk score may be performed periodically, in response to receiving information about a finding, or in response to other triggers. In a typical configuration, the TVMSS can be configured to compute the overall risk score when one or more new inputs are received. For instance, receipt of a CVSS score following the publishing of a newly identified vulnerability by the TVMSS may cause the computation of an overall risk score. In another example, computation of an overall risk score may be triggered when an input relating to an existing vulnerability changes, such as the installation of vulnerable software on more critical systems (i.e., the tier information, described below). Computation of an overall risk score can likewise be triggered manually used specified inputs or periodically.

An example involving a computing system, such as the TVMSS introduced previously, can be used to introduce certain concepts. The computing system may be used for, for example, execution of a risk model to determine an overall risk score for a particular computing environment. In the simplest example, it may be desirable to determine an overall risk score upon receipt of information about a new finding. For instance, a security engineer may receive information about a bug in software used in a computing environment in their purview with implications for network security. The information about the bug may be posted to a public forum that hosts known vulnerabilities. Rather than be faced with a manual evaluation of every such finding, the overall risk score can be automatically computed and used to prioritize mitigation efforts, including both manual and automatic responses to the bug.

To determine an overall risk score associated with the bug using the risk model, the computing system receives a number of inputs such as external information about the bug (e.g., CVSS data), details about the computing environment that may be impacted, and so on. The inputs can be used to compute individual risk factor scores associated with individual risk factors using individual risk factor functions. In other words, given an individual risk factor (e.g., the finding severity), an individual risk factor score can be computed using an individual risk factor function (e.g., the CVSS score associated with the bug report divided by 10).

Likewise, the risk model may include composite risk factors used to compute composite risk factor scores using composite risk factor functions. The composite risk factor functions may receive individual risk factor scores, other composite risk factor scores, or other numerical data as input. The composite risk factor functions may also include weights applied to certain terms that control the relative importance of those terms to the computed composite risk factor score. For example, a composite risk factor score associated with the computing environment's exposure to the bug may be calculated using a composite risk factor function that is a weighted sum of the finding severity and another individual risk factor, the frequency of the finding, a measure of the prevalence of the bug in the computing environment.

Finally, the overall risk score for the computing environment is computed using a final composite function. The final composite function is itself a weighted combination of composite risk factor scores, such as the exposure computed above. The overall risk score can be output to a downstream consumer of the score to generate alerts, notifications, etc. as well as, in some examples, cause automatic mitigation actions to occur. In this example, the bug finding may result in an overall risk score of 8.8-a relatively high score for this computing environment that may warrant immediate action to mitigate the risk thus assessed.

In practical settings, risk is not assessed one finding at a time. Risk must instead be assessed for a given period of time for a particular network context (e.g., a relatively isolated subnetwork of a larger network). For these scenarios, the overall risk scores computed using the techniques of this disclosure described above can be aggregated to determine an aggregate risk score that reflects the risk to the computing environment in the face of a number of findings and other inputs, during a particular period of time. For example, a computation technique such as a log-weighted average of one or more overall risk scores computed for a period of time or for a portion of a computing environment can be used to distill a large number of overall risk scores to a single number. This number can be used to determine or initiate responses, including both manual mitigation efforts and automatic, programmatic responses.

The techniques of the present disclosure constitute a significant improvement to the technical field of risk assessment in the context of computing environments. In particular, as described above, existing approaches for assessing security risk for a computing environment are inadequate because they fail to prioritize mitigation efforts consistently or appropriately. Moreover, existing approaches may lack the capability to determine or cause automatic mitigation actions. The technical field of risk assessment in the context of computing environments thus lacks a flexible, robust, accurate method for determining risk for computing environment and for taking automatic steps to counter that risk. The techniques can be used to compute a risk score for various contexts (e.g., time spans, network portions, hardware and/or software, etc.). The risk score thus computed can be used for a variety of downstream purposes including for the initiation of automatic security responses.

Additionally, the computed risk score can be used for prioritization of mitigation efforts within any arbitrary grouping. In other words, the computed risk score can be ordered or ranked and resources can be assigned on the basis of these orderings. This is enabled through consistent aggregation of total risk over delineations of scope like service, realm, line of business, or time periods. As a result, the techniques are flexible and can accommodate varying degrees of data quality from inputs and be calibrated over time. Likewise, the methodologies are broadly compatible with a large variety of inputs, including both manual and automatically generated input data. The techniques result in an overall risk score output that can be understood or accepted by non-security professionals that is also compatible with widely used standards. The risk scores computed using the techniques of this disclosure are further amenable to aggregation using various computation techniques. As a result, the computed aggregated risk can ensure that a small number of high risks will not be hidden when there is a high number of low risks.

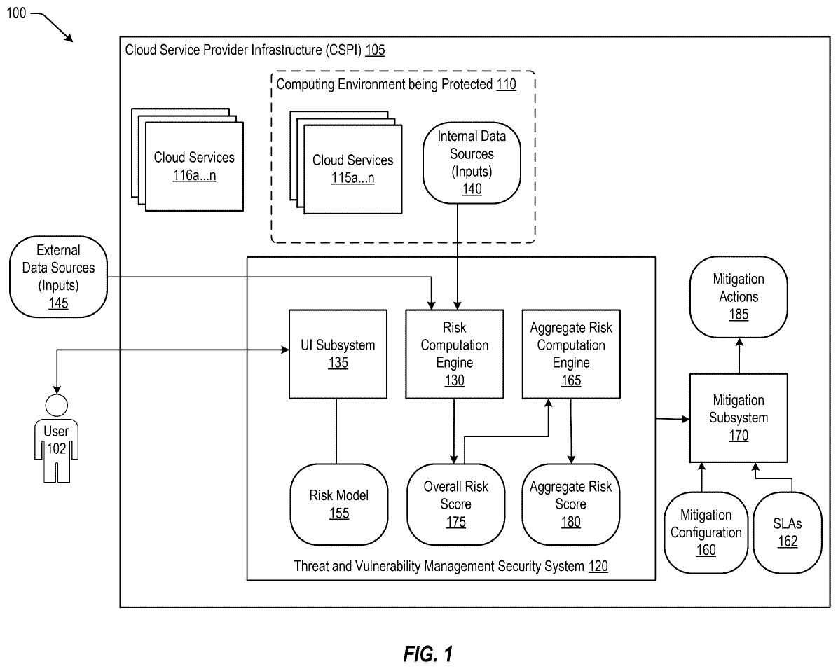

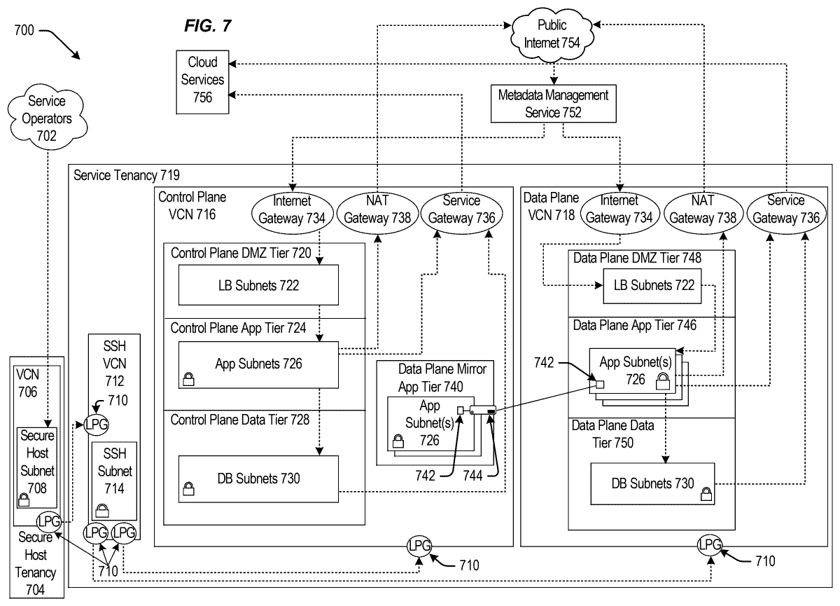

FIGS. 1-6C and the accompanying description below describe examples and embodiments related to the improved techniques described in this disclosure. FIGS. 7-11 depict examples of architectures for implementing cloud infrastructures for providing one or more cloud services, where the infrastructures may incorporate teachings described herein.

### Techniques for Assessing Security Risk at Scale for a Computing Environment

### System Overview

FIG. 1 depicts a system 100 for assessing security risk at scale for a computing environment, according to some examples of the present disclosure. System 100 includes components hosted by Cloud Service Provider Infrastructure (CSPI) 105. The CSPI 105 may include a large, networked collection of scalable computing resources and services that are provided to customers on-demand for various computing tasks. The CSPI may be used for a large variety of general-purpose and specialized cloud computing tasks such as web hosting, data analytics, machine learning services, storage, application development, operational and security monitoring, among many others. Some of these services are represented schematically in system 100 as cloud services 115a . . . n and 116a . . . n.

A dotted line is used to denote a computing environment being protected 110 (hereinafter “computing environment”). The dotted line schematically represents a subset of the computing resources provided by the CSPI 105. For example, the computing environment 110 may include a web server and a database accessible over a subnetwork configured by a customer of the CSPI 105 and provided by the cloud services 116a . . . n accessible from within the computing environment 110. From the standpoint of the customer, or more specifically, a system or network administrator (hereinafter “administrator”) acting on behalf of the customer, the computing environment 110 can be effectively infrastructure over which they have responsibility, including the security of the computing environment 110.

In general, computing environment 110 can include any combination of components including hardware, software, virtual machines, networking components, and so on, including components that are provided or offered by the CSPI 105 as well as components external to the CSPI 105. For instance, the computing environment 110 may include user client devices that are connected to the CSPI 105 over a network.

As discussed above, securing the computing environment 110 can be a very challenging problem, particularly for large, complex computing environments 110 with vastly more components than the simple example above. Consequently, an administrator may be concerned with assessing the risk faced by the computing environment 110, at both a very granular level (e.g., what is the risk for a single known vulnerability) as well as at the macroscopic level (e.g., what is the risk faced due to all known vulnerabilities). Risk, as used herein, is a measure of the extent to which a system or organization (e.g., a CSP) is threatened by a potential circumstance or event. Thus, with respect to computing environment 110, risk is a measure of the extent to which computing environment 110 in particular is threatened by a potential threat or threats.

In system 100, the CSPI 105 provides a Threat and Vulnerability Management Security System (TVMSS) 120 to provide a risk assessment services for the computing environment 110. The TVMSS 120 may be a cloud service, similar to the cloud services 115a . . . n and 116a . . . n. Although depicted in FIG. 1 as a component of the CSPI 105, in some examples, the TVMSS may be hosted externally to the CSPI 105, such as when the TVMSS 120 is an external physical or virtual server. The TVMSS 120 may include components implemented in software, hardware, or a combination thereof.

TVMSS 120 includes various components that can use the risk model 155 to generate outputs such as an overall risk score 175 and an aggregate risk score 180. For computation of risk, the TVMSS includes a risk computation engine 130. The risk computation engine 130 may be, for example, a software component or module, implemented in hardware, or any combination thereof. In some examples, the risk computation engine 130 executes program code for receiving TVMSS inputs, computing individual and composite risk factor scores, computing an overall risk score 175 using various computation techniques, and outputting the overall risk score 175, among other operations.

Some computations of the risk computation engine 130 are based on the risk model 155. The risk model 155 may include information or data that specifies how individual risk factor scores, composite risk factor scores, and weights can be arithmetically combined to generate an overall risk score 175. The risk model 155 may be in any suitable format for this purpose. For example, the risk model 155 may be cached or persisted in the TVMSS 120 as a data structure or expression that includes representations of the individual risk factor scores, composite risk factor scores, and weights. The risk model 155 may be represented as, for instance, a set of text-based configuration information, binary data structures, structured data, or other suitable format.

It should be stressed that the risk model 155 is a flexible and thus editable representation. For example, the TVMSS 120 includes a UI subsystem 135 that can be used to edit the risk model 155 according to the needs of the administrator assessing risk for computing environment 110. The UI subsystem 135 can provide a UI to a suitable client device that can be operated by user 102 to, for example, configure the risk model 155, update and maintain the mitigation configuration 160, and so on. The UI may be provided using a suitable technology such as web-based framework or a native desktop application framework. The user 102 (and client device) is external to the CSPI 105 and may be, for example, an administrator responsible for the security of the computing environment 110 that is a part of the CSPI 105.

For computation of the overall risk score 175, the risk model 155 receives inputs from internal data sources 140 and external data sources 145, which can each refer to numerous data sources within and without the CSPI 105, respectively. Examples of internal data sources 140 include information about the computing environment (e.g., services, tiers, etc.) or information about implemented security controls. Examples of external data sources 145 include externally computed scores (e.g., CVSS) or threat intelligence information.

The overall risk score 175 can be computed in response to receiving, by the risk computation engine 130, an input. For instance, information about a new vulnerability may be published in a public database of vulnerabilities, an external data source 145. The information about the new vulnerability, in concert with a number of other inputs from internal data sources 140 and external data sources 145, may cause the computation of the overall risk score 175. Other inputs may similarly act as triggers for computation of the overall risk score 175. The overall risk score 175 can likewise be calculated periodically or in response to a manual activation.

In some examples, it may be desirable to assess aggregate risk. For example, aggregate risk may be assessed for a given computing environment over a period of time, for a limited subset or scope of the computing environment, a combination of both time and limited scope, or other aggregate context. To this end, the system 100 includes an aggregate risk computation engine 165. The aggregate risk computation engine 165 may be, for example, a software component or module, implemented in hardware, or any combination thereof. In some examples, the aggregate risk computation engine 165 executes program code for computing an aggregate risk score 180 using various computational techniques and outputting the aggregate risk score 180. The time and/or network scopes may be identified using a UI provided by the UI subsystem 135.

In response to computation of the overall risk score 175 and/or the aggregate risk score 180, the system 100 can include a mitigation subsystem 170 for taking manual or automatic action if the score exceeds a predetermined threshold or meets some other predefined criteria. The mitigation subsystem 170 receives a mitigation configuration 160 which can include information about particular actions to take, predefined thresholds, authentication and authorization information, and so on. The mitigation configuration 160 can be updated, edited, or deleted using a suitable UI as provided by UI subsystem 135. The predefined thresholds may be defined with granularity and specificity. For instance, an example predefined threshold may apply to vulnerabilities of a certain type that are exposed to certain systems. A different predefined threshold may be apply for the same vulnerability as exposed to a different set of systems.

The mitigation subsystem 170 can also receive information about Service Level Agreements (SLAs) 162 that can further define the responses and conditions under which responses should be undertaken. SLAs 162 may include agreements between the CSPI 105 provider and customers relating to obligations in response to various security-related scenarios. For instance, the SLAs 162 may specify that a manual or automatic response to an aggregate risk score above a particular threshold must take place within a specified period of time.

The mitigation subsystem 170 can perform various mitigation actions 185 in response to the overall risk score 175 and/or the aggregate risk score 180 exceeding certain predefined thresholds. The mitigation actions 185, shown here as a simplified box, can affect various systems and subsystems of CSPI. The mitigation subsystem 170 may be configured with sufficient configuration (e.g., network addresses) and authentication/authorization information to perform the mitigation actions 185. A non-limiting list of examples of mitigation actions 185 include actions such as isolating compromised network segments, disabling user accounts, automatically patching software, reconfiguring firewalls, terminating vulnerable processes, redirecting network traffic, and so on.

### Risk Model

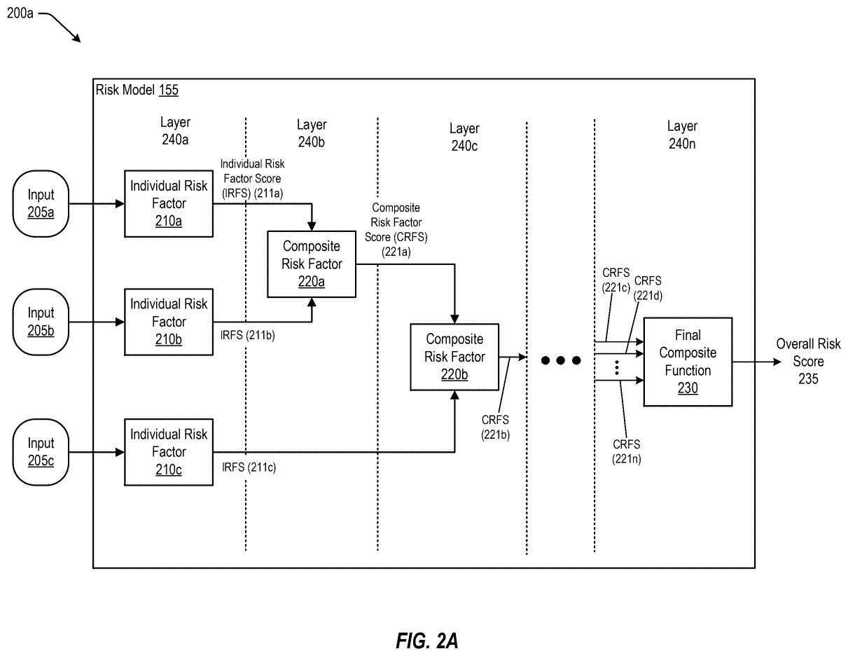

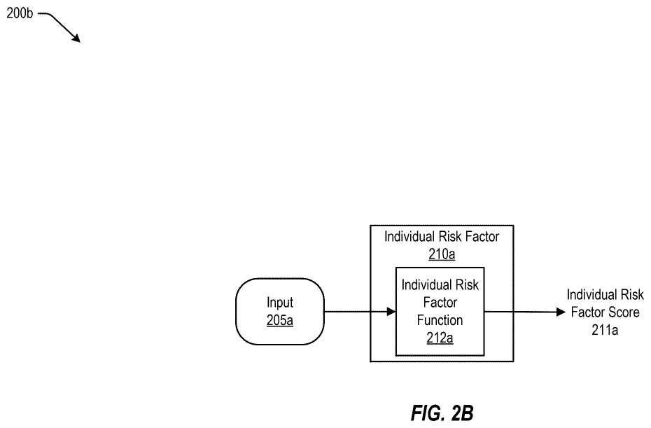

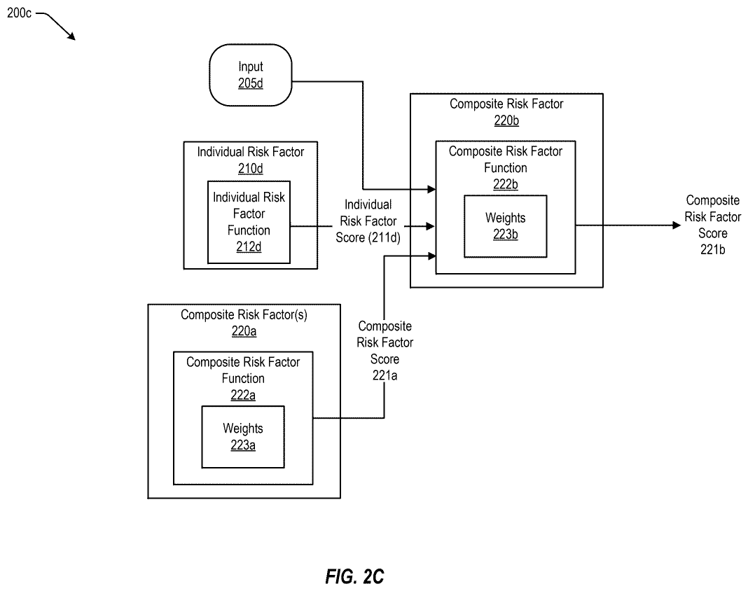

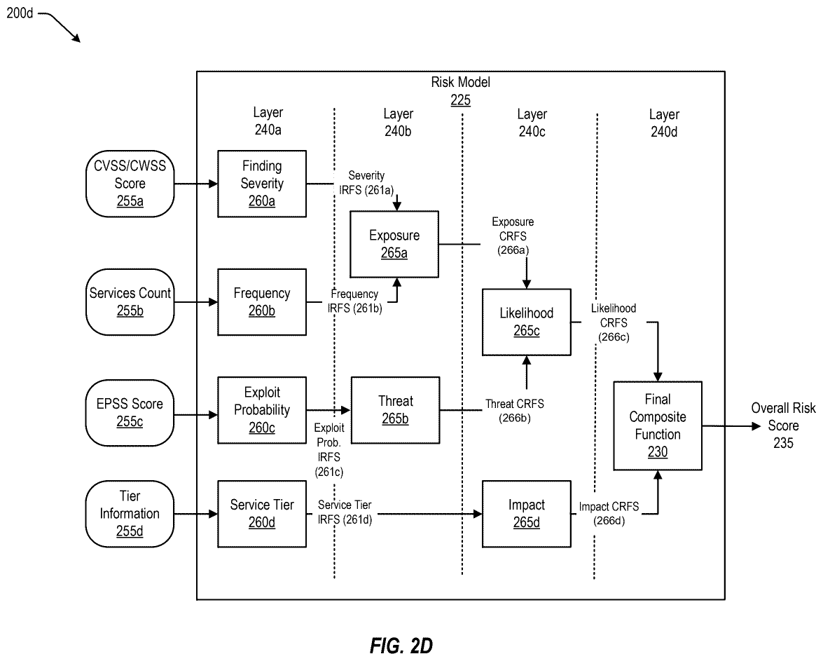

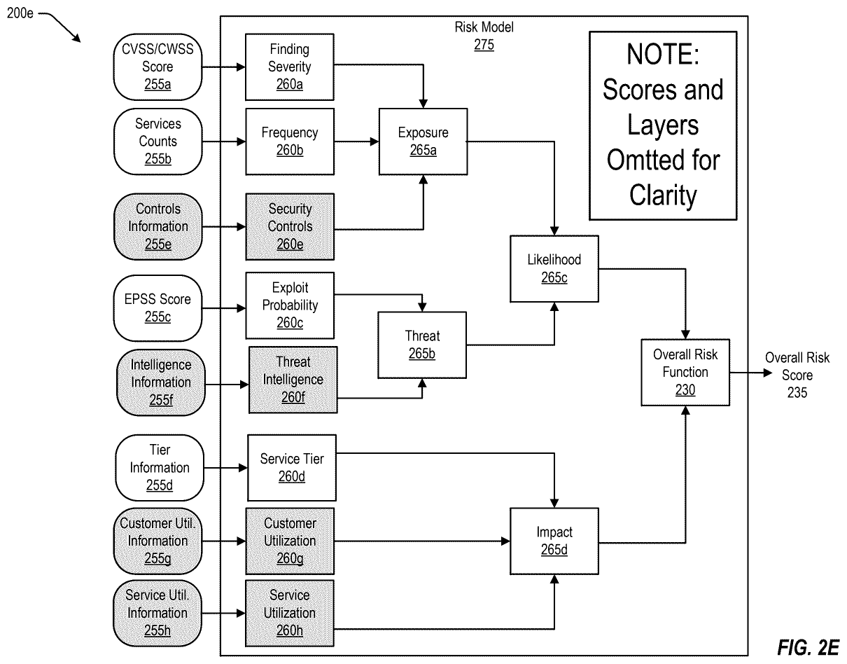

FIGS. 2A-2E depict schematic representations of examples of a risk model or components of a risk model, according to some examples of the present disclosure. The risk model depicted schematically in FIGS. 2A-2E is presented as a representation of risk model 155 discussed above with respect to FIG. 1, but it should be stressed that the risk model 155 described is a non-limiting example. The risk model 155 can include any combination of inputs, individual risk factors, composite risk factors, weights, or other parameters combined using any suitable computation technique. The flexibility enabled by the risk model 155, as described herein, constitutes a powerful advantage of these techniques for assessing security risk at scale for a computing environment disclosed herein.

FIG. 2A shows a schematic representation 200a of a simplified risk model 155, according to some examples of the present disclosure. In representation 200a, the components of risk model 155 are depicted with generality for illustrative purposes. Various embodiments will include a variety of specific instances of the general components described. Particular examples of risk models are described in FIGS. 2D and 2E below.

Risk model 155 is computed using a series of layers 240a . . . n, in which each layer includes a set of computations to perform before advancing to the next layer or in parallel with computations in the current layer. Following the computations of the final layer, 240n, the overall risk score 235 is output. In the first layer 240a, a set of individual risk factors 210a . . . c is computed. Although three individual risk factors 210a . . . c are shown in FIG. 2A, various implementations may have any number of individual risk factors. For each individual risk factor in the set of individual risk factors 210a . . . c, during layer 240a, an individual risk factor score 211a . . . c (corresponding to individual risk factors 210a . . . c, respectively) is computed using an individual risk factor function (not shown for clarity). The individual risk factor functions for individual risk factors 210a . . . c have, as input parameters, as least one of the inputs 205a . . . c. Representation 200a depicts each individual risk factor 210a . . . c as receiving one input 205a . . . c, but in various examples, the individual risk factors 210a . . . c may have one or more inputs 205a . . . c and the inputs 205a . . . c can each be input parameters for more than one individual risk factor 210a . . . c.

The inputs 205a . . . c can include any quantitative or qualitative data supplied to the risk model 155. As described above with respect to FIG. 1, the inputs 205a . . . c may include internal data sources 140 and external data sources 145. The inputs 205a . . . c may be received in a variety of formats (e.g., plain text, data structures, binary data, etc.) and in some examples may require conversion to a quantitative format suitable for computation using the individual risk factor functions for the individual risk factors 210a . . . c. For example, quantitative data may be received as “raw” data that may require pre-processing including unit conversions, rounding, normalization, etc. Qualitative data may require conversion to a numerical format according to the definitions of the individual risk factors 210a . . . c, which may then again require pre-processing prior to computation of the individual risk factor score 211a . . . c.

In the second and third layers 240b,c, a set of composite risk factors, including composite risk factors 220a,b, are computed. During layers 240b,c, composite risk factor scores 221a,b are computed for composite risk factors 220a,b, respectively using composite risk factor functions (not shown for clarity). Each of the composite risk factor functions associated with the composite risk factors 220a,b receives as input at least two input parameters. The input parameters to the composite risk factor functions can be individual risk factor scores 211a . . . c, other composite risk factor scores 221a,b, inputs 205a . . . c, or other quantitative inputs not shown, according to various embodiments of risk model 155. Between layer 240c and final layer 240n, three dots are shown to illustrate that there may be an arbitrary number layers during which composite risk factors are computed in addition to the layers 240b,c shown in FIG. 2A, according to the particular risk model configuration.

At the final layer 240n, a final composite function 230 is used to compute the overall risk score 235 for the computing environment. The final composite function 230 receives as input at least two composite risk factor scores 221c . . . n. The composite risk factor scores 221c . . . n may include the composite risk factor scores 221a,b or may be associated with other composite risk factors not shown (i.e., in the implied layers between layer 240c and final layer 240n).

Turning next to FIG. 2B, FIG. 2B shows a schematic representation 200b of an individual risk factor 210a that is a component of risk model 155, according to some examples of the present disclosure. An individual risk factor score 211a is computed for the individual risk factor 210a using the individual risk factor function 212a. The individual risk factor function 212a receives as input parameters one or more inputs. In this example, representation 200b shows a single input 205a, but the individual risk factor function 212a can receive any number of inputs.

Some examples of individual risk factors 210a . . . c include finding severity, finding frequency, exploit probability, or service tier. These examples, and others are described in detail below in FIGS. 2D and 2E. The individual risk factor function 212a may involve a computation technique applied to or based on the input 205a. For example, the individual risk factor function 212a may perform an arithmetic or mathematical operation on the input 205a, use the input 205a to look up another value, use the input 205a as is or after a suitable normalization technique, apply the input 205a to a particular heuristic, or other computation technique.

Turning next to FIG. 2C, FIG. 2C shows a schematic representation 200c of a composite risk factor 210b that is a component of risk model 155, according to some examples of the present disclosure. A composite risk factor score 221b is computed for composite risk factor 220b using composite risk factor function 222b. In general, the composite risk factor function 222b may receive as input parameters one or more inputs 205a . . . c, one or more individual risk factor scores 211a . . . c, one or more composite risk factor scores 221a . . . n, or other quantitative input. For instance, in some examples, the composite risk factor function 222b uses at least two individual risk factor scores 211a . . . c. In another example, the composite risk factor function 222b uses at least two composite risk factor scores 221a . . . n computed for at least two other composite risk factors 220a,b.

In the example representation 200c, the composite risk factor function 222b receives as input parameters input 205d, individual risk factor score 211d, and composite risk factor score 221a. Individual risk factor score 211d is itself computed using individual risk factor function 212d for individual risk factor 210d. Likewise, composite risk factor score 221a is computed using composite risk factor function 222a for composite risk factor 220a. The composite risk factor function 222a may itself receive a number of input parameters (not shown) as well as use weights 223a, as will be described in more detail in the next paragraph.

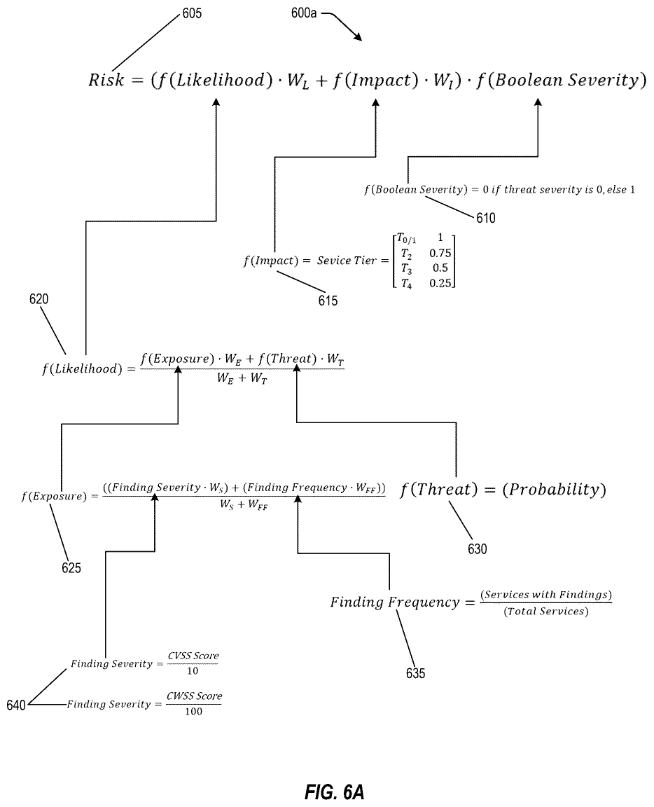

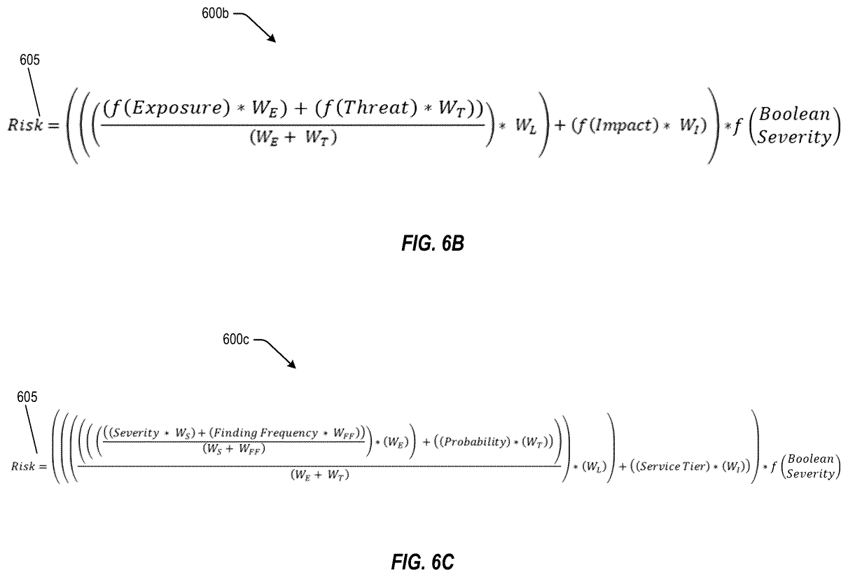

In addition to the input 205d, individual risk factor score 211d, and composite risk factor score 221a, the composite risk factor function 222b also includes weights 223b. The input 205d, individual risk factor score 211d, and composite risk factor score 221a, along with the weights may be combined to compute the composite risk factor score 221b using a suitable computation technique. For example, the composite risk factor function 222b may perform an arithmetic or mathematical operation on the three input parameters. For instance, the three input parameters can be added, subtracted, multiplied, or divided, as well as some combination of these operations. In another example, the three input parameters may be input to a mathematical function. Input parameters may be repeated one or more times. Other computation techniques include lookup tables, other mathematical operations, direct use of input 205d as is or after a suitable normalization technique, or other computation techniques. The weights 223b may be applied to one or more terms of the composite risk factor function 222b to control the relative contribution of those terms. Some weights 223b may be used, in some examples, more than once and can be applied to the terms of the composite risk factor function 222a using any suitable arithmetic operation. In some examples, weights 223b can be combined (e.g., added) and then applied to one or more terms of the composite risk factor function 222a. Examples of composite risk factor functions are described below in FIGS. 2D, 2E, and 6A-C.

In various examples, the weights 223b can control the contributions of the input parameters to the composite risk factor function 222b. For instance, in the first example given above involving the composite risk factor function 222b using at least two individual risk factor scores 211a . . . c, the weights 223b control contributions of each of the at least two individual risk factor scores to the computation of the composite risk factor score 221b. In the second example above involving the composite risk factor function 222b using at least two composite risk factor scores 221a . . . n computed for at least two other composite risk factors 220a,b, the weights 223b control contributions of each of the at least two individual risk factor scores to the computation of the composite risk factor score 221b.

Turning next to FIG. 2D, FIG. 2D shows a schematic representation 200d of a particular implementation of risk model 155, according to some examples of the present disclosure. Representation 200d is cosmetically similar to representation 200a, however the inputs 205a . . . c, individual risk factors 210a . . . c, composite risk factors 220a,b, etc. have been replaced with examples corresponding to one particular risk model 225 configuration. As with representation 200a, the risk model 225 includes layers 240a . . . d that are executed sequentially, each layer receiving inputs parameters from the previous layer and proceeding from left to right (in these representations) to produce an overall risk score 235.

Representation 200d includes a number of inputs 255a . . . d in layer 240a that correspond to the inputs 205a . . . c shown in representation 200a. The inputs 255a . . . d are each input parameters to the individual risk factor functions of individual risk factors 260a . . . d, respectively. However, as stressed above, in other examples, individual risk factors 260a . . . d may have one or more inputs 255a . . . d as well as other quantitative or qualitative data sources.

In some examples, the overall risk score 235 is computed periodically or in response to receiving information about a finding. A finding can refer generally to a vulnerability or weakness that may be associated with a given computing environment. A weakness can refer generally to a condition in a software, firmware, hardware, or other component that, under certain circumstances, could contribute to the introduction of one or more vulnerabilities. A vulnerability, then, can refer generally to a flaw or bug in the component that can be exploited by a threat actor to perform unauthorized actions within a computer system. In other words, weaknesses are potential areas of vulnerability and vulnerabilities are actual exploitable circumstances (e.g., a specific weakness in a specific component) that may exist presently in a computing environment.

Some examples of findings include a buffer overflow vulnerability in a web application that can allows remote code execution, a SQL injection flaw in a database-driven application that may expose sensitive data, an unpatched remote code execution vulnerability in a widely used operating system, or an authentication bypass vulnerability in a network device that could allow unauthorized access. These examples are provided to convey the type and seriousness of the findings involved, but it is stressed that these are merely examples, and that findings can include any event or circumstance that may affect the assessment of security risk at scale for a given computing environment.

Individual risk factor 260a relates to the severity of a finding (hereinafter “finding severity”). Finding severity 260a is a measure of the extent of the damage to the computing environment that may result following a successful exploitation of a finding. For example, a high-severity finding may involve a vulnerability in a web server that allows an attacker to gain administrative control over the server. In contrast, a low-severity finding may be a database security setting that potentially exposes non-sensitive information.

The finding severity 260a individual risk factor function is based on a Common Vulnerability Scoring System (CVSS) score or Common Weakness Scoring System (CWSS) score input 255a. As mentioned above, the CVSS score is an open standard for generating a numerical score for a vulnerability-type finding reflecting its severity. The CWSS is another open standard for generating a numerical score for a weakness-type finding reflecting its severity.

Both the CVSS and the CWSS are derived from the Common Weakness Enumeration (CWE) and the Common Vulnerability Enumeration (CVE). The CWE is an open standard including a list of common software and hardware weakness types that may have security ramifications. In turn, the CVE is a public database that includes identified, defined, or cataloged publicly disclosed vulnerabilities. These vulnerabilities are mapped, by the CVE, to underlying root cause CWEs. An approximate CVSS score can be determined using the mapping from CVEs to CWEs. Various examples may use CVSS version 3.1, 4.0, or other suitable versions of CVSS. Likewise, a CWSS score can be derived from CWE. The risk model 225 can use either or both of CVSS or CWSS to compute the finding severity 260a.

In some examples, the finding severity individual risk factor score (“IRS”) 261a can be computed using a finding severity function. Examples of the finding severity individual risk factor function that receive the CVSS score or CWSS score input 255a include:

$$Finding Severity = \frac{CVSS Score}{10} \qquad ( 1 )$$

$$and$$

$$Finding Severity = \frac{CWSS Score}{100} \qquad ( 2 )$$

In these examples, the CVSS and CWSS scores are received as numerical values between 10 and 100, respectively, such that the division operation in the example finding severity functions normalize the finding severity IRS 261a to a numerical value between 0.0 and 1.0.

Individual risk factor 260b relates to the frequency of a finding (hereinafter “finding frequency”). Finding frequency 260b can be a measure of the scope or “footprint” of an exposure to a finding. In some examples, finding frequency 260b may be referred to as “blast radius.” In contrast to finding severity 260a, which measures the severity of a specific finding for a particular software or hardware instance, finding frequency 260b adjusts the overall risk score 235 based on the presence of the finding across a computing environment.

In some examples, the finding frequency 260b can be measured by determining the total percentage of services (e.g., particular software or hardware instances) that have the same finding. In this respect, finding frequency 260b can function as a multiplier to finding severity 260a within the overall risk score 235. One example of an individual risk factor function associated with the finding frequency 260b individual risk factor is given by:

$$Finding Frequency = \frac{\# Services with Findings}{Total \# Services} \qquad ( 3 )$$

As a fraction of total services, this example function for computing the finding frequency IRS 261b will typically output a numerical value between 0.0 and 1.0.

Individual risk factor 260c relates to the exploit probability of a finding. The individual risk factor function associated with the exploit probability 260c is based on, in some examples, the Exploit Prediction Scoring System (EPSS). The EPSS is an open scoring standard managed by an international, non-profit association of computer security incident response teams for estimating the probability that a software vulnerability will be exploited in the computing environment. The EPSS project can provide an EPSS score for every published CVE. In some examples, the EPSS for a particular CVE may be null or empty.

In these cases, a default value derived from the average of all EPSS scores may be used. For example, a default EPSS of 0.03577 can be used. The default EPSS score may be selected to maintain awareness of a particular CVE while not over-arbitrarily estimating its exploit probability and wasting mitigation resources unnecessarily. In some examples, because CVEs are mapped to CWEs, an approximate EPSS for every CWE tied to a known CVE can also be derived. In such cases, an overall risk score 235 can be computed to assess the risk for each CWE associated with the CVE as well as the CVE itself.

One example of an individual risk factor function associated with the exploit probability 260c individual risk factor is given by:

$$Exploit Probability = EPSS Score \qquad ( 4 )$$

This example function for computing the exploit probability IRS 261c can be proportional (or exactly equal to) to the EPSS score and may thus be on the same numerical scale as the EPSS scale, which is a numerical value between 0.0 and 1.0.

Individual risk factor 260d relates to the service tier 260d associated with a finding. In this context, “service tier” can refer to a categorization of service criticality. For example, one definition of service tiers adopted by some administrators includes four tiers. Tier 1 can include mission critical services that can have a direct impact on the core mission of an organization or mission critical services having users of that are members of the organization. Tier 2 can include important services that may have a direct impact to Tier 1 services or users. Tier 3 can include operational services that can have a direct impact to the efficiency or operating costs across the organization. Tier 4 can include administrative services that can have a direct impact at an individual level (e.g. user quality of life or user productivity).

In some examples, an extended model for service tiers can be used which includes a Tier 0. Tier 0 can be a subset of Tier 1 services that may include, for example, services that are essential for recovering from large scale events (e.g., major outages or security incidents). One example of an individual risk factor function associated with the service tier 260d individual risk factor is given by:

$$Service Tier = [ \begin{matrix}{T}_{0 / 1} & 1 \\ {T}_{2} & 0.75 \\ {T}_{3} & 0.5 \\ {T}_{4} & 0.25\end{matrix} ] \qquad ( 5 )$$

This example individual risk factor function for computing the service tier IRS 261d for individual risk factor service tier 260d can be implemented as a lookup table or associative array and may output a numerical value between 0.0 and 1.0. In some examples, a linear function or other computation method may be used in lieu of the lookup table.

Risk model 225 includes layer 240b. Following computation of the individual risk factor scores 261a . . . d, the composite risk factors 265a and 265b can be evaluated. In various examples, the composite risk factors 265a and 265b can be evaluated in parallel or in sequence. For instance, in some examples, computation of the composite risk factor score (“CRS”) for exposure 266a may proceed while the individual risk factor scores 261c and 261d are still being computed. In that case, two layers 240a and 240b may be undergoing computation operations simultaneously (e.g., using parallel processing).

The composite risk factor for exposure 265a relates to a composite measure of how dangerous a vulnerability can be or how prevalent the vulnerability is in a given computing environment. In some examples, the composite risk factor function for the composite risk factor exposure 265a may be function of finding severity IRS 261a and/or finding frequency IRS 261b. One example composite risk factor function for the composite risk factor exposure 265a is given by:

$$Exposure = f ( Finding Severity , Finding Frequency ) \qquad ( 6 )$$

$$Exposure = \frac{( ( Finding Severity \cdot {W}_{S} ) + ( Finding Frequency \cdot {W}_{FF} ) )}{{W}_{S} + {W}_{FF}} \qquad ( 7 )$$

This example composite risk factor function for the composite risk factor exposure 265a includes weights W_{S} and W_{FF}. In this example, the weights control the contributions of the included individual risk factor scores 261a, b in two ways. First, the individual risk factor scores 261a, b are multiplied by their respective weight. This use controls the relative contribution of each term to the sum. In some examples, the weights may represent the fraction or percentage of the composite risk factor exposure 265a that is made up by each of the individual risk factor scores 261a, b. In this case, the sum of the weights may correspond to a unit value such as 1, 10, or 100, according to the scale of the selected weights. For instance, if W_{S}=7, corresponding to 70% of the composite risk factor exposure 265a being severity, then W_{FF}=3, corresponding to 30% of the composite risk factor exposure 265a being finding frequency. Controlling the relative contributions using weights in this way assumes that the terms are on the same or similar numeric scale. Second, the weighted sum of the individual risk factor scores 261a, b is divided by the sum of the weights. This normalizes the exposure CRS 266a to the same numerical scale as the individual risk factor scores 261a, b, which in this example is a numerical value between 0.0 and 1.0. Although the examples in this paragraph are discussed in the context of the composite risk factor exposure 265a, the constraints on the weights may correspond to other composite risk factors.

The composite risk factor for threat 265b relates to a circumstance or event, such as a malicious user or compromised password, that can act on a vulnerability or takes advantage of a weakness. In other words, the composite risk factor for threat 265b may be a measure of the probability a vulnerability or weakness will be taken advantage of or exploited.

In the example risk model 255 of FIG. 2D, the composite risk factor function for the composite risk factor threat 265b is a function of the IRS for exploit probability 261c and may be given by:

$$Threat = Exploit Probability \qquad ( 8 )$$

This illustrates an example of a composite risk factor function that includes only a single IRS (exploit probability IRS 261c) and no weights. In other example risk models, such as the example shown in FIG. 2E, the composite risk factor for threat 265b can include additional inputs, some of which may be weighted. As the threat CRS 266b is on the same numerical scale as the exploit probability IRS 261c, it will also be a numerical value between 0.0 and 1.0.

Risk model 225 includes layer 240c. Following computation of the composite risk factor scores 266a, b, the composite risk factors 265c and 265d can be evaluated. The composite risk factor for likelihood 265c relates to the likelihood of a security compromise occurring but may not necessarily be a statistical probability. The likelihood 265c can be a composite measure of likelihood of a security compromise based on an organization's exposure to a finding and available information on threats acting on the underlying weakness or vulnerability. Consequently, the composite risk factor function for the composite risk factor for likelihood 265c may be a function of exposure 265a and threat 265b. One example composite risk factor function for the composite risk factor likelihood 265c is given by:

$$Likelihood = f ( Exposure , Threat ) \qquad ( 9 )$$

$$Likelihood = \frac{f ( Exposure ) \cdot {W}_{E} + f ( Threat ) \cdot {W}_{T}}{{W}_{E} + {W}_{T}} \qquad ( 10 )$$

This example composite risk factor function for the composite risk factor likelihood 265c includes weights W_{E} and W_{T}. As described above, the weights control the contributions of the included composite risk factor scores 266a, b by both controlling the relative contribution of the CRSs 266a, b and by normalizing the CRS 266c to a numerical value between 0.0 and 1.0.

The composite risk factor for impact 265d relates to a measure of criticality or danger, given a hypothetical security compromise. For example, impact 265d may relate to failure modes of factors and systems such as user utilization, service utilization, service tier, and so on. The impact 265d can be based on one or a combination of these factors. In one example composite risk factor function for the composite risk factor impact 265d, only the service tier factor, computed in layer 240a as service tier IRS 261d contributes to impact 265d. The example composite risk factor function is given by:

$$Impact = f ( Service Tier ) = Service Tier \qquad ( 11 )$$

In this example, the CRS 266d is normalized to a numerical value between 0.0 and 1.0, as described above with respect to the individual risk factor for service tier 260d.

In layer 240d, the overall risk score 235 is computed using the final composite function 230. The final composite function 230 can, in some examples, use at least two composite risk factor scores computed for at least two composite risk factors. In example risk model 225, the final composite function 230 uses the CRSs 266c, d for two composite risk factors 265c, d, in particular the likelihood 265c and impact 265d.

In this example risk model 225, the final composite function 230 is given by:

$$Risk = f ( Likelihood ) \cdot {W}_{L} + f ( Impact ) \cdot {W}_{I} \qquad ( 12 )$$

This example final composite function 230 includes a weighted sum of the CRSs for composite risk factors likelihood 265c and impact 265d. The weights control the relative contributions of the CRSs 266c, d. The weights may be selected to cause the overall risk score 235 to be a number between 0 and 10. For example, if the composite risk factors likelihood 265c and impact 265d are normalized to be numbers between 0 and 1, as described above, the weights for the final composite function 230 may be selected to sum to 10. The final composite function 230 can be used to compute the overall risk score 235. The overall risk score 235 can then be output to downstream consumers, automatic mitigation systems, and so on. In some examples, the final composite function 230 may be multiplied or otherwise constrained by a composite risk factor that ensures that the computed overall risk score 235 is 0 in the event that certain inputs (e.g., the CVSS sore 255a) is 0.

Turning next to FIG. 2E, FIG. 2E shows a schematic representation 200e of another particular implementation of risk model 155, according to some examples of the present disclosure. The example risk model 275 of FIG. 2E is similar in many respects to the example risk model 225 of FIG. 2D. Risk model 275 includes a number of additional inputs, individual risk factors, and contributions to composite risk factors. Note that risk model 275 is shown without layers, IRSs, and CRSs labeled as in FIG. 2D for clarity, but these concepts and examples are equally applicable in the example of risk model 275. The new inputs and individual risk factors discussed with respect to FIG. 2E are shown with light grey shading.

Example risk model 275 includes an additional input for security controls information 255e that can be used to compute an individual risk factor for security control efficacy 260e. A security control may include a safeguard or countermeasure designed to protect the confidentiality, integrity, and availability of the computing environment. Security controls can be evaluated by, for example, their effectiveness at limiting exposure or access to a vulnerability. In that example, more effective control can result in less exposure to the vulnerability at issue. In some examples, security controls can be mapped to abstractions used in open standards or public vulnerability database, such as specific CVEs. In example risk model 275, the individual risk factor for security control efficacy 260e includes an individual risk factor function that can be used to compute an IRS that can contribute to the composite risk factor for exposure 265a based on the security controls information 255e input.

Example risk model 275 also includes an additional input for intelligence information 255f that can be used to compute an individual risk factor for threat intelligence 260f. Threat intelligence can include information potential threat actors that has been aggregated, transformed, analyzed, interpreted, or enriched to provide the context for risk assessment. A threat actor may include people or systems that have the capacity to exploit various vulnerabilities or weaknesses. In example risk model 275, the individual risk factor for threat intelligence 260f includes an individual risk factor function that can be used to compute an IRS that can contribute to the composite risk factor for threat 265b based on the threat intelligence 255f input.

The threat intelligence 260f input may include one or more components. For instance, the threat intelligence 260f input may include information about the intent of potential threat actors. Intent can be a measure of how relevant a particular target (e.g., the computing environment or subset thereof) is to the goals or desired outcomes of the potential threat actor, the consequences the potential threat actor seeks to avoid, or how strongly the potential threat actor seeks to achieve desired outcomes or avoid undesirable consequences. The threat intelligence 260f input may include information about the capability of potential threat actors. Capability can be a measure of the resources, skill or expertise, knowledge, and opportunity of a potential threat actor. The threat intelligence 260f input may further include information about the targeting of potential threat actors. Targeting can be a measure of how broadly, narrowly, or persistently the potential threat actor targets certain targets. For example, threat intelligence 260f about one particular potential threat actor may indicate that the potential threat actor is actively trying to attack the computing environment.

Example risk model 275 further includes additional inputs for customer utilization information 255g and service utilization information 255h. The inputs for customer utilization information and service utilization information 255g, h can be used to compute individual risk factor for customer utilization 260g and service utilization 260h, respectively. Customer utilization information 255g can be a measure of the number users consuming a particular system or service in the computing environment, as may be determined by available metering or monitoring information. Service utilization information 255h can be a measure of the number of CSPI 105 internal or organizational users that are consuming a particular system or service in the computing environment, as may be similarly determined by available metering or monitoring information. In example risk model 275, the individual risk factors for customer utilization 260g and service utilization 260h each include an individual risk factor function that can be used to compute an IRS that can contribute to the composite risk factor for impact 265d.

### Methods for Assessing Security Risk at Scale for a Computing Environment

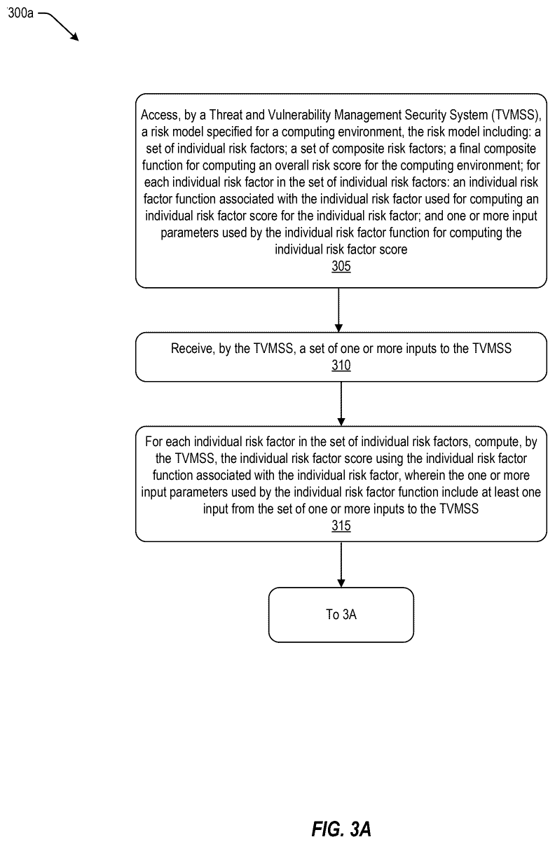

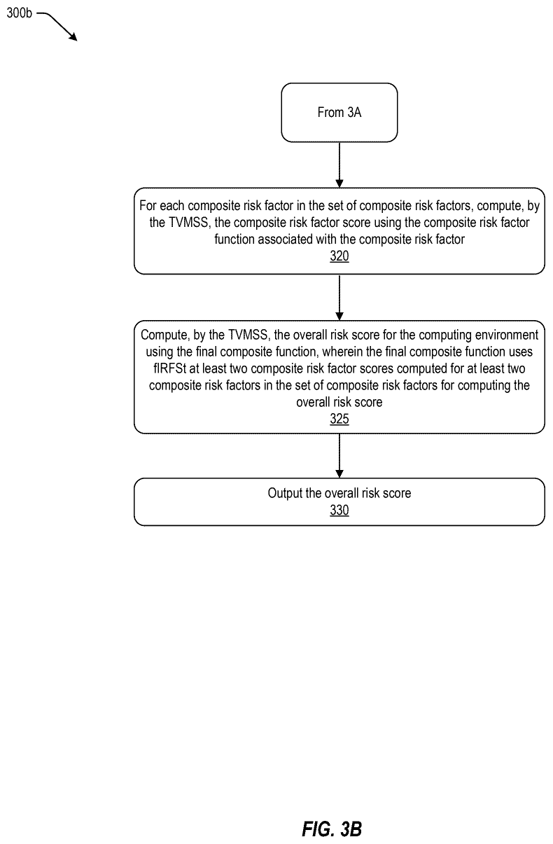

FIGS. 3A-3B depict a simplified flowchart showing a method for assessing security risk at scale for a computing environment, according to some examples of the present disclosure. The method 300 depicted in FIGS. 3A-3B may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method 300 presented in FIGS. 3A-3B and described below is intended to be illustrative and non-limiting. Although FIGS. 3A-3B depict the various processing steps occurring in a particular sequence or order, this is not intended to be limiting. In certain alternative embodiments, the processing may be performed in some different order, or some steps may also be performed in parallel.

At block 305, a computing system, such as a TVMSS, accesses, a risk model specified for a computing environment. The risk model includes a set of individual risk factors, a set of composite risk factors, and a final composite function for computing an overall risk score for the computing environment. Each individual risk factor in the set of individual risk factors includes an individual risk factor function associated with the individual risk factor used for computing an individual risk factor score (“IRS”) for the individual risk factor and one or more input parameters used by the individual risk factor function for computing the individual risk factor score. Each composite risk factor in the set of composite risk factor includes a composite risk factor function associated with the composite risk factor used for computing a composite risk factor score (“CRS”) for the composite risk factor and at least two input parameters used by the composite risk factor function for computing the composite risk factor score.

For example, the risk model may be the risk model 225 of FIG. 2D or the expanded risk model 275 of FIG. 2E. Many other implementations of the risk model are possible due to the flexibility of the risk model and the method described herein. In some examples, the risk model is designed to output the overall risk score on a particular numerical scale, such as 0.0 to 1.0 or 0.0 to 10.0, and so on. The risk model may be implemented as a series of layers, in which the outputs of each layer feed the inputs of the next layer. The layers may be executed sequentially or in parallel when there are no mathematical dependencies between the computations.

At block 310, the computing system receives a set of one or more inputs. The inputs may include, for example, measures of finding severity (e.g., the CVSS score of the finding as a proxy for the severity of the finding), the frequency of the finding (e.g., how often the software bug occurs), the probability of a finding being exploited, or the service tier of the computing environment being protected, among many other possible factors. Examples of inputs are described above with respect to FIG. 2E in the descriptions of inputs 255a . . . d.

The inputs may be received by the TVMSS using any suitable method for conveyance. For example, as described above with respect to FIG. 1, the inputs may include internal data sources 140 (e.g., tier information 255d). The internal data sources 140 may be accessed by querying a database, reading files from disk, querying a suitable internal API, and so on. Likewise, the inputs may include external data sources 145 (e.g., CVSS score 255a) that can be accessed using a suitable API, scraped from the web, received via email or other message source, and so on.

At block 315, the computing system computes, for each individual risk factor in the set of individual risk factors, the IRS using the individual risk factor function associated with the individual risk factor, in which the one or more input parameters used by the individual risk factor function include at least one input from the set of one or more inputs to the computing system. In some examples, the individual risk factor can reflect a particular real-world concern (e.g., a threat from outside the computing environment). For example, the individual risk factor finding severity 260a corresponds to a particular vulnerability or weakness identified by the public external to the computing environment. The individual risk factor function associated with the individual risk factor, then, can correspond to a description of the computation technique that can be used to arrive at the IRS, which is the quantification of the individual risk factor. For example, the finding frequency 260b for the finding can be determined by dividing the total number of services in the computing environment with the number of affected services in the affected computing environment, as shown above with respect to FIG. 2D. A similar individual risk factor function may be used for each individual risk factor.

At block 320, the computing system computes, for each composite risk factor in the set of composite risk factors, the CRS using the composite risk factor function associated with the composite risk factor. The composite risk factor function may include one or more individual risk factors, another composite risk factor, or an input. The composite risk factor again reflects the real-world concern, now a combination of concerns. For instance, the likelihood of an event occurring is related to at least the probability of the event and the exposure a computing environment has to the event. The composite risk factor function again gives a description of the computation technique that can be used to arrive at the CRS, the quantification of the composite risk factor.

For example, one composite risk factor function may combine the individual risk factors for finding severity 260a and finding frequency 260b using addition or other suitable computation technique. Additionally, the contributions of the terms of each composite risk factor can be controlled by one or more user-configurable weights. For instance, in the example of the composite risk factor combining severity 260a and finding frequency 260b, each of finding severity 260a and finding frequency 260b can be associated with one or more weights using, for example, multiplication or other computation technique to control their relative contribution to the CRS. The weights can likewise be used to normalize the CRS or to control the contributions using other computation techniques (e.g., multiplication to boost contribution and division to reduce contribution).

At block 325, the computing system computes the overall risk score for the computing environment using the final composite function, in which the final composite function uses at least two composite risk factor scores computed for at least two composite risk factors in the set of composite risk factors for computing the overall risk score. For example, the overall risk score may be an arithmetic combination of several individual risk factors and several composite risk factors, some or all of which may be weighted in various ways. The various individual and composite risk factors may be normalized such that the overall risk score is a simple number (e.g., a floating point value between 0.0 and 10.0).

At block 330, the computing system outputs the overall risk score to another computing system or other downstream consumer of the overall risk score. The other computing system may automatically respond to the receipt of the score and, for example, determine an automatic response. For example, if the overall risk score satisfies certain predetermined criteria, automatic mitigation responses may be taken. In a simple example, automatic responses may be taken when the overall risk score calculated over the range 0.0 to 10.0 for a finding exceeds 9.5. For instance, information about the finding may be sent to security engineers using suitable notifications, messages, alarms, alerts, and so on.

In some examples, the TVMSS can itself determine a response based upon the overall risk score exceeding a predetermined threshold. For example, if the overall risk score for a particular finding, over a specified period of time, for a designated subset of the computing environment, etc. exceeds a predetermined threshold, a component of the TVMSS such as the mitigation subsystem 170 of FIG. 1 can determine a response. For instance, the mitigation subsystem 170 may automatically initiate a software patching process or “quarantine” a potentially compromised portion of the computing environment, among may other possible responses.

Following computation and output of the overall risk score, some examples may include additional methods for risk calibration. For example, some risk model configurations may be designed with variable parameters that can enable the calibration of risk assessment results over time. Initial implementations of risk models may include initial values for certain constants, functions, weights, etc. based on empirical observations. As the risk model is used for generation of overall and aggregate risk scores, additional empirical observations may provide indications to adjust certain parameters. For example, certain inputs may be of known low quality (e.g., an unreliable externally computed score). Variable parameters can be chosen and adjusted to minimize discrepancies caused by low quality inputs.

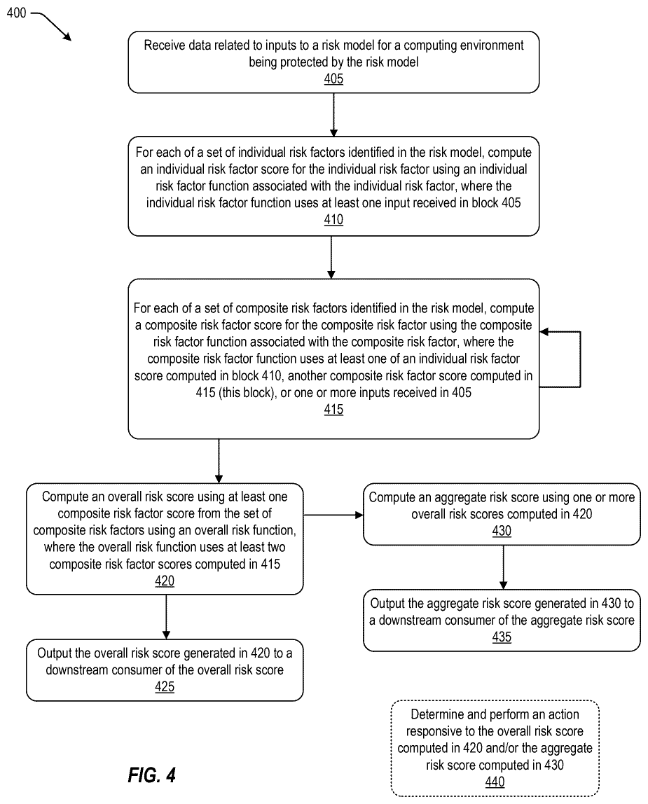

FIG. 4 depicts a simplified flowchart showing a method for assessing security risk at scale for a computing environment, according to some examples of the present disclosure. The method 400 depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method 400 presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order, or some steps may also be performed in parallel.

At block 405, a computing system, such as a TVMSS, receives data related to inputs to a risk model for a computing environment being protected by the risk model. Similarly to block 310 above, the inputs may include data from either or both of internal data sources 140 and external data sources 145. FIGS. 2D and 2E show a number of different inputs that may be used in example risk models 225 and 275, respectively. In addition to these examples, the flexibility of the techniques disclosed herein enables the use of many more inputs. A non-limiting list of addition example inputs includes network data, system logs, configuration data, firewall configuration information or activity, application usage data, software update or patch information, incident reports or bug trackers, access logs, encryption key or password store information, or software version information.

At block 410, the computing system computes, for each of a set of individual risk factors identified in the risk model, an individual risk factor score for the individual risk factor using an individual risk factor function associated with the individual risk factor, where the individual risk factor function uses at least one input received in block 405, similarly to block 315 above. In some examples, individual risk factors can be individually measured data points used within the risk model. The individual risk factor functions associated with the individual risk factors are chosen, in some examples, to yield a numerical value between or equal to 0.0 and 1.0. Some examples may use integers, while other examples may use floating point values with a specified degree of precision. When the individual risk factors are thus limited, it can ensure, arithmetically, that the composite risk factor scores and overall risk score are similarly scaled or bounded.

At block 415, the computing system computes, for each of a set of composite risk factors identified in the risk model, a composite risk factor score for the composite risk factor using the composite risk factor function associated with the composite risk factor, where the composite risk factor function uses at least one of an individual risk factor score computed in block 410, another composite risk factor score computed in 415 (this block), or one or more inputs received in 405, similarly to block 320 above. The use of another composite risk factor score to compute a composite risk factor score is denoted by the loopback arrow shown on block 415. Composite risk factor functions may include, for example, particular groupings of individual risk factors and/or other composite risk factors. For instance, the composite risk factors used in the example risk model 225 include likelihood 265c, exposure 265a, threat 265b, and impact 265d. The risk model is flexibly designed so that individual and composite risk factors can be added, removed, or moved to between and among composite risk factor functions.

The composite risk factor functions may each include one or more weights. The weights may be combined arithmetically, individually or in combination, with the terms in the composite risk factor functions. For instance, one individual risk factor score may be multiplied by a sum of two weights, while a composite risk factor score may be divided by a product of two weights. Weight can allow for the relative importance of individual or composite risk factors within a composite function to be balanced against one another. Weight functions can be applied within any composite function. In some examples of individual risk factor functions that include a single term no weight is used.

At block 420, the computing system computes an overall risk score using at least one composite risk factor score from the set of composite risk factors using an overall risk function, where the overall risk function uses at least two composite risk factor scores computed in 415, similarly to block 325. As illustrated in FIGS. 2D and 2E, the risk model can be represented hierarchically using a series of layers 240a . . . d. Computation of the overall risk score may thus take place sequentially, as a series of layers 240a . . . d, in which each layer awaits the completion of the computations of the previous layers. In another example, the layers 240a . . . d can be computed in parallel. In this example, computation can proceed asynchronously whenever sufficient data is available to complete the computational step. In some examples, computation of the overall risk score can be facilitated using a stream-processing or event-based processing paradigm in which inputs or completed computations are enqueued for processing and dequeued by downstream consumers when all inputs are available.

At block 425, the computing system outputs the overall risk score generated in 420 to a downstream consumer of the overall risk score, similarly to block 330. Downstream consumers of the overall risk score may include systems that can perform manual or automatic mitigation actions such as the mitigation subsystem 170. Other examples of downstream consumers may include automated monitoring systems, dashboard or notification generation systems, threat intelligence platforms, network operations centers, governance or regulatory systems, public threat databases, and so on.

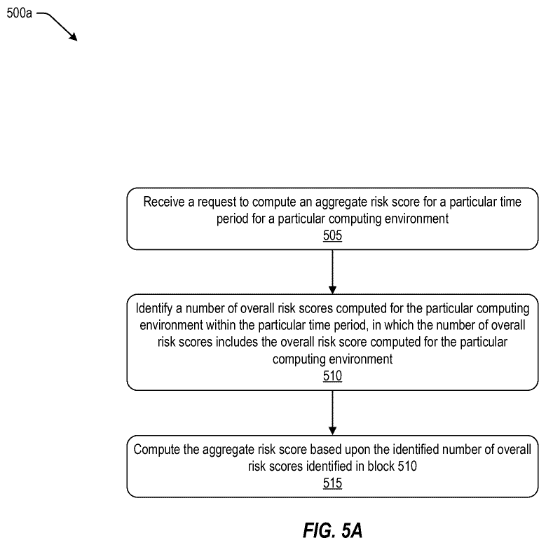

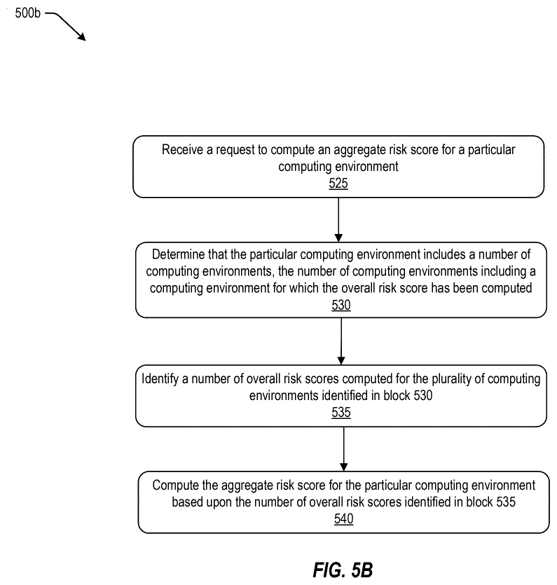

The overall risk score may be persisted in the TVMSS using a suitable persistent store such as a relational database or a filesystem. The computed overall risk score can be stored in association with various identifying information and metadata that can be later queried to identify particular subsets of computed overall risk scores for computation of aggregate risk, as described below with respect to FIGS. 5A and 5B. For example, the overall risk scores may be persisted in association with information about the finding, timestamps, inputs used for computation, affected network portions, and so on.

At block 430, the computing system computes an aggregate risk score using one or more overall risk scores computed in 420. One difficulty associated with risk assessment involves risk aggregation. For example, high risks can be obscured under a high volume of low risks. Naïve approaches to risk aggregation, such as an unnormalized simple sum of overall risk scores cannot yield useful comparisons amongst each other because of the overly inclusive scale (e.g., an aggregate risk score of 1,000 may include 100,000 low overall risk scores or 10 high overall risk scores). At block 430, some examples may use a log-weighted average to aggregate the individual risk in any given arbitrary scope. The scope can used to define the selection of overall risk scores to include in the aggregate computation (e.g., over a particular time, for a particular sub-system or sub-network, etc.).

At block 435, the computing system outputs the aggregate risk score generated in 430 to a downstream consumer of the aggregate risk score. As with the overall risk score in block 425, the aggregate risk score can be similarly output to downstream consumers such as the mitigation subsystem 170 to cause manual or automatic mitigation actions 190, as well as others such as the examples given above.

At block 440, the computing system determines and performs an action responsive to the overall risk score computed in 420 and/or the aggregate risk score computed in 430. As discussed in blocks 425 and 435, a mitigation subsystem 170 or the like can be configured to perform actions manually or automatically in response to reception of overall risk scores or aggregate risk scores under various conditions. For example, the mitigation subsystem 170 can be configured to take an automatic mitigation action when an overall risk scores or aggregate risk score exceeds a predetermined threshold. The predetermined threshold for a particular overall risk scores or aggregate risk score may be a function of various aspects of the TVMSS. In this respect, the predetermined threshold can vary depending upon the specific circumstances under which the overall risk scores or aggregate risk score was computed. For instance, an overall risk score computed in response to reception of a finding that pertains to a critical software program executing in the computing environment can be assigned a low threshold for mitigation. In contrast, an overall risk score computed in response to reception of a finding that pertains to a less critical software program used in the computing environment may be assigned a higher threshold for automatic or manual mitigation.

FIGS. 5A-5B depict simplified flowcharts showing methods for assessing aggregate security risk at scale for a computing environment, according to some examples of the present disclosure. The methods 500a and 500b depicted in FIGS. 5A-5B may be implemented in software (e.g., code, instructions, program) executed by one or more processing units (e.g., processors, cores) of the respective systems, using hardware, or combinations thereof. The software may be stored on a non-transitory storage medium (e.g., on a memory device). The methods 500a and 500b presented in FIGS. 5A-5B and described below is intended to be illustrative and non-limiting. Although FIGS. 5A-5B depict the various processing steps occurring in a particular sequence or order, this is not intended to be limiting. In certain alternative embodiments, the processing may be performed in some different order, or some steps may also be performed in parallel.

As introduced above with respect to blocks 430 and 435 of FIG. 4, computation of aggregate risk can be desirable to contextualize risk or to compare risk among differing time periods and/or scopes. FIG. 5A describes an example method 500a for computing aggregate risk for a particular period of time. At block 505, a computing system, such as a TVMSS, receives a request to compute an aggregate risk score for a particular time period for a particular computing environment. For example, consider an administrator whose area of responsibility includes the particular computing environment. The administrator may be concerned with the risk faced by his or her organization at any given moment. But the assessment of risk must generally be bounded in time or scope to be computable. The administrator may thus provide an indication to the TVMSS, using a suitable UI, an indication to compute aggregate risk for a particular time period. For instance, the administrator may specify a time period that includes the last 24 hours, the last week, the last month, the last year, and so on.

At block 510, the computing system identifies a number of overall risk scores computed for the particular computing environment within the particular time period, in which the number of overall risk scores includes the overall risk score computed for the particular computing environment. For example, the TVMSS may search a database or other persisted store of overall risk scores computed during the particular period of time, in which each overall risk score was computed in response to reception of a finding, periodically, or in response to some other cause. For instance, the administrator may query a database in which previously computed overall risk scores are persisted and receive a number of overall risk scores for the particular period of time.

At block 515, the computing system Compute the aggregate risk score based upon the identified number of overall risk scores identified in block 510. The aggregate risk scores may be computed using a computation technique. Various computation techniques can be used. Some computation techniques may be chosen to weight higher risks more heavily than lower risks, such that higher risks have a greater influence on the computed aggregate risk score.

One example computation technique involves a log-weighted average to compute the aggregate risk score. For example, one example approach for computing the log-weighted average is given by:

$$Aggregate Risk = exp ( \frac{\sum ( ln R ) \cdot {W}_{RS}}{\sum {W}_{RS}} ) \qquad ( 13 )$$

In this expression, the sums are over all overall risk scores, R, determined for the particular time period. The weights, W_{RS}, are a function of R. In other words, each distinct value of R will result in different W_{RS} value. The function W_{RS}(R) can use various approaches to map R to W_{RS}. In on example approach, the weights increase exponentially at a predetermined rate (e.g., 1.3999 per integer interval). For instance, in the latter example, 0 risk can be mapped to a weighting of 0.01 to define the function as:

$${W}_{RS} ( R ) = 0.01 \cdot {1.3999}^{R} \qquad ( 14 )$$

This formulation yields weights of about 0.0143 for R=1 and 0.2959 for R=10. More generally, this may be written as:

$${W}_{RS} ( R ) = {W}_{{RS}_{0}} \cdot {Rate}^{R} \qquad ( 15 )$$

The initial proposed rate and minimum (zero risk) weight value W_{RS}_{₀} in the example above is selected to make a risk of 5 approximately 3 times as much risk as a risk score of 1 and a risk score of 10 approximately 5 times as much risk as a risk score of 5.

In some examples, the weights computed using method described above may be adjusted over time by adjusting, for example, the exponential rate, the minimum (zero risk) weight value, or the maximum (10 risk) weight value. Such adjustments can be used to enable administrators to base the initial weight selection on subjective assessments of risk and calibrate the constant values over time based on empirical experience over time to increase accuracy.

In addition to the example of the log-weighted average described above, other approaches, including differing arithmetic approaches or constant values may be used. For example, some implementations may use a simple arithmetic mean or plain weighted average, include exponential smoothing factors, or other computation technique.

FIG. 5B describes an example method 500b for computing aggregate risk for a particular scope of a particular computing environment. At block 525, the computing system receives a request to compute an aggregate risk score for a particular computing environment. As in block 505, the particular scope may be specified using a suitable UI via client device. The particular computing environment may include a portion of a network, a specification of particular hardware or software systems, a group of users or roles, a particular class of vulnerabilities or weaknesses, or other categorization that can be applied to computed overall risk scores. In some examples, the specification of scope may also include a specification of a period of time.

At block 530, the computing system determines that the particular computing environment includes a number of computing environments, the number of computing environments including a computing environment for which the overall risk score has been computed. As in block 510, a database or other persisted store of overall risk scores can be queried using information about the scope defined in block 525. For example, the query may include a list of hostnames or IP addresses to identify overall risk scores that are associated with a portion of a network. At block 535, the computing system identifies a number of overall risk scores computed for the plurality of computing environments identified in block 530. In some examples, the specification of the particular computing environment may also include a specification of a period of time, in which case the query may be further limited using the selected time bounds. However, the method 500b may be used in some examples without a time bound, selecting instead all overall risk scores for the particular scope, for all times.

At block 540, the computing system computes an aggregate risk score for the particular computing environment using the overall risk scores identified in block 535. The aggregate risk score may be computed using a computation technique such as the example approaches described in block 515 above.

In addition to the example processes 500a, b for computing aggregate risk scores described above, an aggregate risk score may be computed for other scenarios as well. For example, an aggregate risk score may be computed for a particular computing environment for a particular duration, for a particular computing environment for all times, for a portion of a computing environment, for several computing environments receiving the same inputs during the same period of time, or other subdivisions of computing environments and time.

FIGS. 6A-6C illustrate an example final composite function of a risk model as well as the components therein, according to some examples of the present disclosure. In FIGS. 6A-6C, the example final composite function is first shown in a simplified form 600a. Partially expanded form 600b shows the simplified form 600a as a composite risk factor function. Fully expanded form 600c shows the composite form 600b using individual risk factors. The forms 600a . . . c thus presented illustrate both a particular example of the risk model 155 as well as the sequential computational layers 240a . . . n described above with respect to FIG. 2A for assessing security risk at scale for a computing environment. It is stressed that the examples of FIGS. 6A-6C correspond to a particular risk model (similar to the risk model 225 of FIG. 2D), but that many other implementations are possible using the flexible techniques of this disclosure, that may include other individual risk factors or composite risk factors, different inputs, and so on.

FIG. 6A depicts simplified final composite function 600a. For simplicity, the final composite function 600a will be described in the context of a finding. In simplified final composite function 600a, each term of the final composite function 600a is shown reduced to a compact notation. For example, simplified final composite function 600a shows overall risk score 605 as a product of two composite risk factors including a first composite risk factor and a second composite risk factor.

The first composite risk factor includes a sum of a weighted likelihood composite risk factor 620 and a weighted impact composite risk factor 615. The second composite risk factors is an unweighted Boolean severity composite risk factor 610. The composite risk factor function associated with the unweighted Boolean severity composite risk factor 610 is given as a heuristic approach to ensure that if the finding severity 640 (discussed below) is 0 that the overall risk score 605 is 0. In other words, even with a finding severity 640 that is equal to 0, the other individual and composite factors could still inadvertently generate a non-zero overall risk score 605, which may be contrary to expectations. In all other cases, the unweighted Boolean severity composite risk factor 610 is 1. The impact composite risk factor 615 is based on a single individual risk factor, the service tier, for which the individual risk factor function is a lookup table.

In this example, the likelihood composite risk factor 620 is shown as a weighted and normalized sum of an exposure 625 composite risk factor and a threat 630 composite risk factor. The exposure 625 composite risk factor is shown as a weighted and normalized sum of a finding severity 640 individual risk factor and a finding frequency 635 individual risk factor. The composite risk factor function for the threat 630 composite risk factor is shown as equal to a predicted exploit probability of the finding based on, for example, the Exploit Prediction Scoring System (EPSS).

FIG. 6B depicts partially expanded final composite function 600b. In partially expanded final composite function 600b, the composite risk factor terms described in the paragraphs above are substituted into the simplified final composite function 600a. FIG. 6C depicts fully expanded final composite function 600c. In fully expanded final composite function 600c, the individual risk factor terms described in the paragraphs above are substituted into the partially final composite function 600b. Fully expanded final composite function 600c is thus representative of the example risk model 225 as may be used in some implementations of assessing security risk at scale for a computing environment.

The examples described above in FIGS. 1-6C for assessing security risk at scale for a computing environment are frequently used to protect a computing environment in a CSPI such as the computing environment 110 and CSPI 105 of FIG. 1. As emphasized above, the security threat for CSPs is particularly acute, given the rising popularity of such services. The following sections describe example architectures for providing a cloud service as may be used in concert with the techniques for assessing security risk at scale for a computing environment described herein.

### Example Architectures for Providing a Cloud Service

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively couple to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

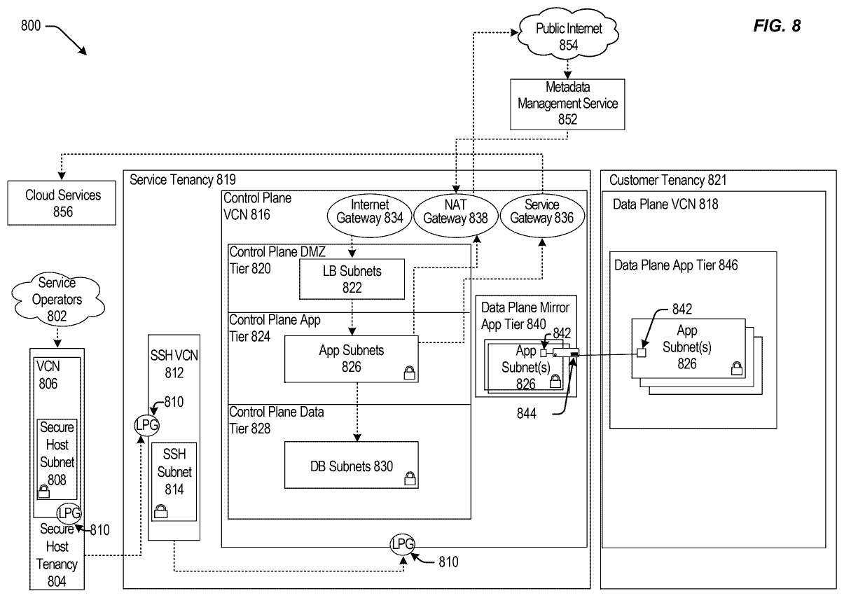

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively couple to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

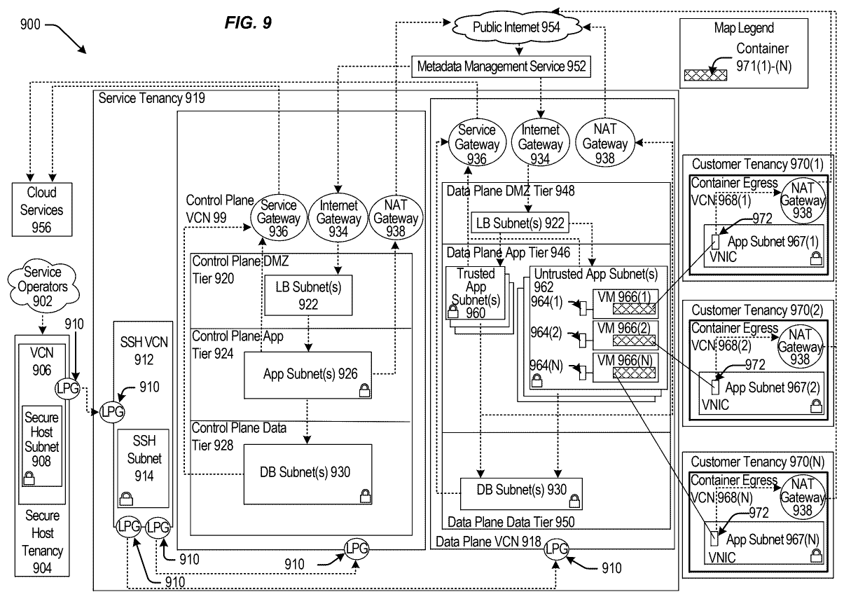

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

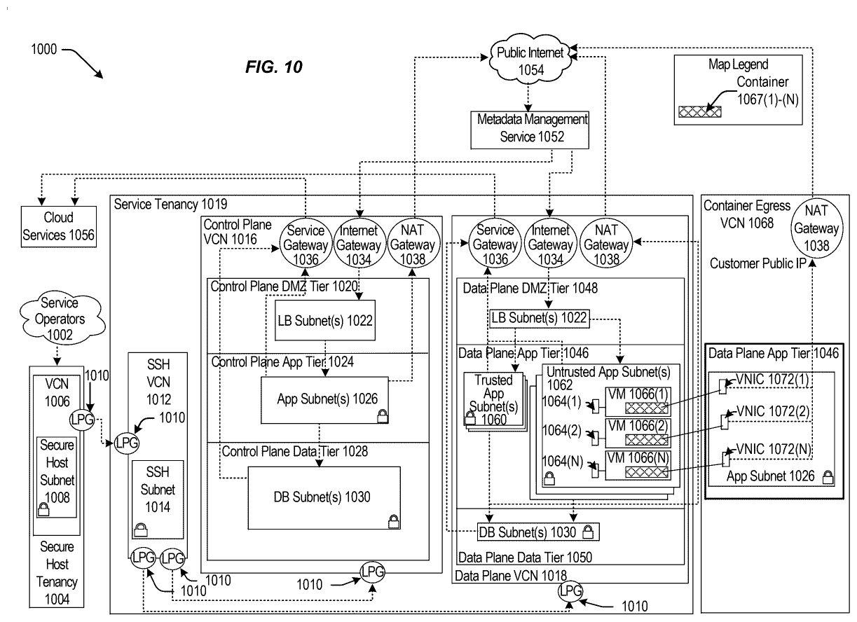

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

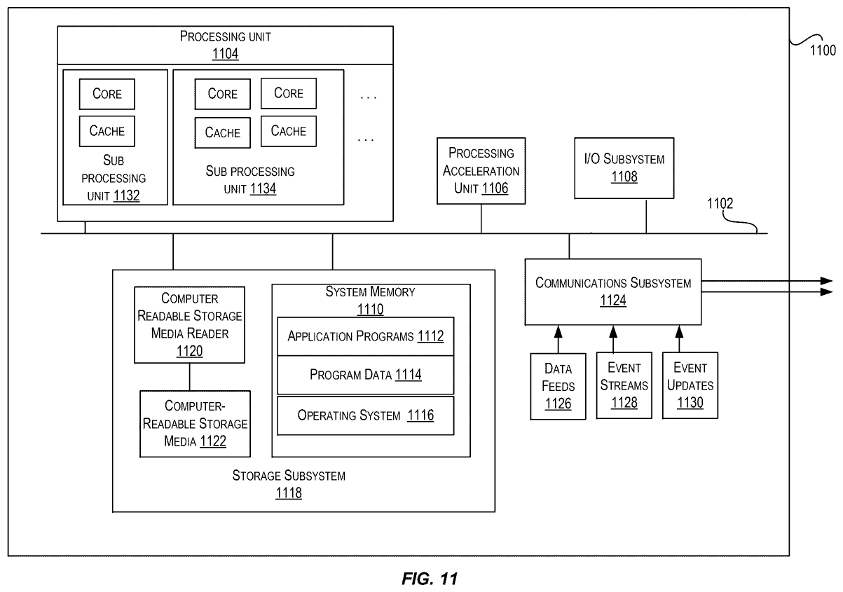

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
accessing, by a Threat and Vulnerability Management Security System (TVMSS), a risk model specified for a first computing environment, the risk model including:
a set of individual risk factors;
a set of composite risk factors;
a final composite function for computing an overall risk score for the first computing environment;
for each individual risk factor in the set of individual risk factors:
an individual risk factor function associated with the individual risk factor used for computing an individual risk factor score for the individual risk factor; and
one or more input parameters used by the individual risk factor function for computing the individual risk factor score; and
for each composite risk factor in the set of composite risk factors:
a composite risk factor function associated with the composite risk factor used for computing a composite risk factor score for the composite risk factor; and
at least two input parameters used by the composite risk factor function for computing the composite risk factor score;
receiving, by the TVMSS, a set of one or more inputs to the TVMSS;
for each individual risk factor in the set of individual risk factors, computing, by the TVMSS, the individual risk factor score using the individual risk factor function associated with the individual risk factor, wherein the one or more input parameters used by the individual risk factor function include at least one first input from the set of one or more inputs to the TVMSS;
for each composite risk factor in the set of composite risk factors, computing, by the TVMSS, the composite risk factor score using the composite risk factor function associated with the composite risk factor;
computing, by the TVMSS, the overall risk score for the first computing environment using the final composite function, wherein the final composite function uses at least two composite risk factor scores computed for at least two composite risk factors in the set of composite risk factors for computing the overall risk score; and
outputting the overall risk score.

2. The method of claim 1, wherein computing, for each composite risk factor in the set of composite risk factors, the composite risk factor score using the composite risk factor function associated with the composite risk factor comprises:
for a first composite risk factor in the set of composite risk factors, using a first composite risk factor function associated with the first composite risk factor to compute a first composite risk factor score for the first composite risk factor, wherein using the first composite risk factor function comprises using at least two individual risk factor scores.

3. The method of claim 2, wherein:
the at least two individual risk factor scores include a first individual risk factor score and a second individual risk factor score; and
the first composite risk factor function includes a first weight associated with the first individual risk factor score and a second weight associated with the second individual risk factor score, wherein the first weight controls a contribution of the first individual risk factor score to the computation of the first composite risk factor score and the second weight controls a contribution of the second individual risk factor score to the computation of the first composite risk factor score.

4. The method of claim 1, wherein computing, for each composite risk factor in the set of composite risk factors, the composite risk factor score using the composite risk factor function associated with the composite risk factor comprises:
for a first composite risk factor in the set of composite risk factors, using a first composite risk factor function associated with the first composite risk factor to compute a first composite risk factor score for the first composite risk factor, wherein using the first composite risk factor function comprises using at least two other composite risk factor scores computed for at least two other composite risk factors.

5. The method of claim 4, wherein:
the at least two composite risk factor scores include a second composite risk factor score and a third composite risk factor score; and
the first composite risk factor function includes a first weight associated with the second composite risk factor score and a second weight associated with the third composite risk factor score, wherein the first weight controls a contribution of the second composite risk factor score to the computation of the first composite risk factor score and the second weight controls a contribution of the third composite risk factor score to the computation of the first composite risk factor score.

6. The method of claim 1, wherein:
the at least two composite risk factor scores include a first composite risk factor score and a second composite risk factor score; and
the final composite function includes a first weight associated with the first composite risk factor score and a second weight associated with the second composite risk factor score, wherein the first weight controls a contribution of the first composite risk factor score to the computation of the overall risk score and the second weight controls a contribution of the second composite risk factor score to the computation of the overall risk score.

7. The method of claim 1, further comprising determining a responsive action based upon the overall risk score exceeding a predetermined threshold.

8. The method of claim 1 wherein the receiving, the computing for each individual risk factor in the set of individual risk factors, the computing for each composite risk factor in the set of composite risk factors, and the computing of the overall risk score are performed periodically or in response to receiving information about a finding.

9. The method of claim 8, further comprising:
receiving a request to compute an aggregate risk score for a first time period for the first computing environment;
identifying a plurality of overall risk scores computed for the first computing environment within the first time period, wherein the plurality of overall risk scores includes the overall risk score computed for the first computing environment; and
computing the aggregate risk score based upon the identified plurality of overall risk scores.

10. The method of claim 8, further comprising:
receiving a request to compute an aggregate risk score for a particular computing environment;
determining that the particular computing environment includes a plurality of computing environments, the plurality of computing environments including the first computing environment;
identifying a plurality of overall risk scores computed for the plurality of computing environments; and
computing the aggregate risk score for the particular computing environment based upon the plurality of overall risk scores.

11. The method of claim 10, wherein computing the aggregate risk score comprises:
using a log weighted average of the plurality of overall risk scores for computing the aggregate risk score; and
each term of the log weighted average includes a weight that increases exponentially in proportion to each respective overall risk score of the one or more overall risk scores.

12. The method of claim 1, wherein:
at least one second input of the set of one or more inputs corresponds to a finding; and
computing the overall risk score comprises computing the overall risk score as a product of a first composite risk factor score and a second composite risk factor score, wherein:
the first composite risk factor score is computed using a first composite risk factor function;
the second composite risk factor score is computed using a second composite risk factor function;
the first composite risk factor function comprises a first sum of a first nested composite risk factor score controlled by a first weight and a second nested composite risk factor score controlled by a second weight, wherein:
the first nested composite risk factor score is based on a likelihood of the finding; and
the second nested composite risk factor score is based on an impact of the finding; and
the second composite risk factor function evaluates to 0 if the severity of the finding is 0 and 1 otherwise.

13. The method of claim 12, wherein:
at least one second input of the set of one or more inputs corresponds includes the Common Vulnerability Scoring System (CVSS) value of the finding or the Common Weakness Scoring System (CWSS) value of the finding; and
the severity of the finding is based on the CVSS value of the finding or the CWSS value of the finding.

14. The method of claim 12, wherein the second nested composite risk factor score based on the impact of the finding is computed using a second nested composite risk factor function that evaluates to a number determined according to a service tier associated with the finding.

15. The method of claim 12, wherein the first nested composite risk factor score comprises a second sum of a third nested composite risk factor score controlled by a third weight and a fourth nested composite risk factor score controlled by a fourth weight divided by a third sum of the third weight and the fourth weight, wherein the third nested composite risk factor score is based on an exposure of the finding and the fourth nested composite risk factor score is based on an exploit probability of the finding.

16. The method of claim 15, wherein:
the third nested composite risk factor score based on the exposure of the finding comprises a fourth sum of a first individual risk factor score controlled by a first individual risk factor weight and a second individual risk factor score controlled by a second individual risk factor weight divided by a fifth sum of the first individual risk factor weight and the second individual risk factor weight, wherein the first individual risk factor score is based on the severity of the finding and the second individual risk factor score is based on a frequency of the finding; and
the frequency of the finding is a quotient of a number of services in the first computing environment having a same finding and a total number of services in the first computing environment.

17. The method of claim 15, wherein the fourth nested composite risk factor score based on the exploit probability of the finding is determined based on a predicted exploit probability of the finding based on the Exploit Prediction Scoring System (EPSS).

18. The method of claim 1, wherein:
one or more inputs of the plurality of inputs correspond to a finding; and
the final composite function is given by:
$$Risk = ( f ( Likelihood ) \cdot {W}_{L} + f ( Impact ) \cdot {W}_{I} ) \cdot f ( Boolean Severity )$$
wherein:
ƒ(Likelihood) is a first composite risk factor score computed using a first composite risk factor function based on at least two composite risk factor scores, given by ƒ(Exposure) and ƒ(Threat);
W_{L} is a first weight that controls a first contribution of the first composite risk factor score;
ƒ(Impact) is a second composite risk factor score based on an impact of the finding;
W_{I} is a second weight that controls a second contribution of the second composite risk factor score; and
ƒ(Boolean Severity) is a third composite risk factor score that can assume one of two possible values based on the severity of the finding.

19. A non-transitory computer-readable medium storing instructions that, when executed by one or more processors, cause the one or more processors to perform operations including:
accessing, by a TVMSS, a risk model specified for a computing environment, the risk model including:
a set of individual risk factors;
a set of composite risk factors;
a final composite function for computing an overall risk score for the computing environment;
for each individual risk factor in the set of individual risk factors:
an individual risk factor function associated with the individual risk factor used for computing an individual risk factor score for the individual risk factor; and
one or more input parameters used by the individual risk factor function for computing the individual risk factor score; and
for each composite risk factor in the set of composite risk factors:
a composite risk factor function associated with the composite risk factor used for computing a composite risk factor score for the composite risk factor; and
at least two input parameters used by the composite risk factor function for computing the composite risk factor score;
receiving, by the TVMSS, a set of one or more inputs to the TVMSS;
for each individual risk factor in the set of individual risk factors, computing, by the TVMSS, the individual risk factor score using the individual risk factor function associated with the individual risk factor, wherein the one or more input parameters used by the individual risk factor function include at least one input from the set of one or more inputs to the TVMSS;
for each composite risk factor in the set of composite risk factors, computing, by the TVMSS, the composite risk factor score using the composite risk factor function associated with the composite risk factor;
computing, by the TVMSS, the overall risk score for the computing environment using the final composite function, wherein the final composite function uses at least two composite risk factor scores computed for at least two composite risk factors in the set of composite risk factors for computing the overall risk score; and
outputting the overall risk score.

20. A security system comprising:
one or more processors; and
one or more computer-readable storage media storing instructions which, when executed by the one or more processors, cause the one or more processors to perform operations including:
accessing, by the security system, a risk model specified for a computing environment, the risk model including:
a set of individual risk factors;
a set of composite risk factors;
a final composite function for computing an overall risk score for the computing environment;
for each individual risk factor in the set of individual risk factors:
an individual risk factor function associated with the individual risk factor used for computing an individual risk factor score for the individual risk factor; and
one or more input parameters used by the individual risk factor function for computing the individual risk factor score; and
for each composite risk factor in the set of composite risk factors:
a composite risk factor function associated with the composite risk factor used for computing a composite risk factor score for the composite risk factor; and
at least two input parameters used by the composite risk factor function for computing the composite risk factor score;
receiving, by the security system, a set of one or more inputs to the security system;
for each individual risk factor in the set of individual risk factors, computing, by the security system, the individual risk factor score using the individual risk factor function associated with the individual risk factor, wherein the one or more input parameters used by the individual risk factor function include at least one input from the set of one or more inputs to the security system;
for each composite risk factor in the set of composite risk factors, computing, by the security system, the composite risk factor score using the composite risk factor function associated with the composite risk factor;
computing, by the security system, the overall risk score for the computing environment using the final composite function, wherein the final composite function uses at least two composite risk factor scores computed for at least two composite risk factors in the set of composite risk factors for computing the overall risk score; and
outputting the overall risk score.
